(19) United States
(12) Patent Application Publication
(10) Pub. No.: US 2026/0290326 A1
(43) Pub. Date: Sep. 24, 2026

(54) SYSTEM

(71) Applicant: SoftBank Group Corp., Tokyo (JP)

(72) Inventor: Hiroki YOSHIZAWA, Tokyo (JP)

(73) Assignee: SoftBank Group Corp., Tokyo (JP)

(21) Appl. No.: 19/565,713

(22) Filed: Mar. 13, 2026

(30) Foreign Application Priority Data
Mar. 19, 2025 (JP) 2025-044534

(51) Int. Cl. G10L 15/16; G06F 40/30; G10L 25/18

(52) U.S. Cl. CPC G10L 15/16; G06F 40/30; G10L 25/18

(57) ABSTRACT

A system includes a processor that is configured to collect audio information and convert the audio information into character information by using a speech recognition technique, generate a prompt for instructing a generative AI model to analyze a topic and extract key points, the prompt being generated based on converted character information received as input, and input the generated prompt into the generative AI model so that the generative AI model analyzes the topic and extracts the key points from the character information.

### CROSS-REFERENCE TO RELATED APPLICATION

This application is based on and claims priority under 35 USC 119 from Japanese Patent Application No. 2025-044534 filed on Mar. 19, 2025, the disclosure of which is incorporated by reference herein.

### BACKGROUND

Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional meeting support systems, it is difficult to efficiently and accurately capture the essential content of spoken discussions and to convert such content into structured information that can be directly used for follow-up tasks. In particular, when only raw audio recordings or simple transcriptions are available, users must manually read through large amounts of text, identify important topics, extract key points, and derive concrete action items, which is time-consuming and prone to human error. Furthermore, existing systems typically do not provide an effective mechanism for detecting when a discussion deviates from the intended subject, nor do they offer interactive feedback that encourages participants to remain on topic in a natural and engaging manner. As a result, meetings are often inefficient, important decisions may be overlooked, and follow-up tasks may not be clearly defined or properly recorded.

### SUMMARY

In order to solve the above-described problems, a system is provided comprising a processor, wherein the processor is configured to collect audio information and convert the audio information into character information by using a speech recognition technique, generate a prompt for instructing a generative AI model to analyze a topic and extract key points based on converted character information received as input, and input the generated prompt into the generative AI model so that the generative AI model analyzes the topic and extracts the key points from the character information. The processor is further configured to identify action items based on the extracted key points and record the action items in a database, thereby automatically structuring meeting outcomes into actionable tasks without manual transcription and analysis. In addition, the processor is configured to generate a predetermined humorous message when the topic deviates from a subject and output a warning by audio or visually based on the predetermined humorous message, so that participants are encouraged to return to the intended topic in a light-hearted manner, improving meeting focus and overall efficiency.

The term “processor” refers to one or more hardware computing elements, such as a central processing unit (CPU), a graphics processing unit (GPU), an application-specific integrated circuit (ASIC), a field-programmable gate array (FPGA), or any combination thereof, configured to execute instructions that implement the functions described in the present specification.

The term “audio information” refers to data representing sound, including but not limited to human speech captured via a microphone or other audio input device, in analog or digital form, that is suitable for processing by a speech recognition technique.

The term “character information” refers to text data obtained by converting audio information or other input into a sequence of characters, symbols, or words that can be processed as textual input by software or models described in the present specification.

The term “speech recognition technique” refers to any algorithm, model, or process, including but not limited to automatic speech recognition (ASR) systems based on statistical methods or machine learning, that converts audio information containing speech into corresponding character information.

The term “prompt” refers to a text or structured input sequence, generated by the processor, that is provided to a generative AI model to specify, guide, or constrain the behavior of the generative AI model, including instructions to analyze a topic and extract key points from character information.

The term “generative AI model” refers to an artificial intelligence model, such as a large language model or other generative model, that is capable of generating text or structured outputs in response to a prompt, including performing analysis of topics and extraction of key points from character information.

The term “topic” refers to a subject, theme, or main point of a discussion or content segment represented by character information, which can be analyzed or identified by the generative AI model based on the prompt generated by the processor.

The term “key points” refers to important pieces of information, including but not limited to decisions, conclusions, requirements, or other salient statements, that are extracted from character information by the generative AI model according to instructions contained in the prompt.

The term “action items” refers to tasks, duties, or follow-up activities that are derived from the key points and that indicate specific actions to be performed, optionally including an assignee, a due date, or other related metadata.

The term “database” refers to any storage system, including but not limited to relational databases, NoSQL databases, file systems, or cloud-based storage services, that stores data such as action items in a manner that allows subsequent retrieval, updating, and management.

The term “predetermined humorous message” refers to a message prepared in advance, including text and/or content suitable for audio output, that is designed to be humorous or light-hearted and that is generated or selected by the processor for output when the topic deviates from a subject.

The term “warning” refers to a notification, alert, or indication output by the system, which is intended to inform users that a certain condition has occurred, such as a deviation of the topic from a subject, and which may be presented by audio output, visual display, or a combination thereof.

The term “audio output” refers to the presentation of sound, including speech or other audio signals, generated by the system via a speaker, headphones, or other audio playback device, to convey information such as a warning or a predetermined humorous message to a user.

The term “visual output” refers to the presentation of information in a visual form, including but not limited to text, icons, images, or graphical user interface elements displayed on a display device, to convey information such as a warning or a predetermined humorous message to a user.

The term “subject” refers to an intended main theme, agenda item, or focus of a discussion or meeting, against which the current topic is evaluated to determine whether the topic has deviated from the intended focus.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

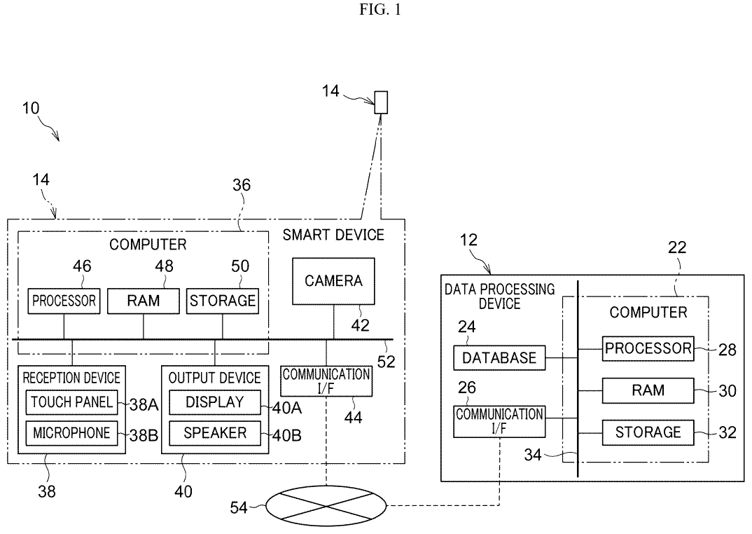

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

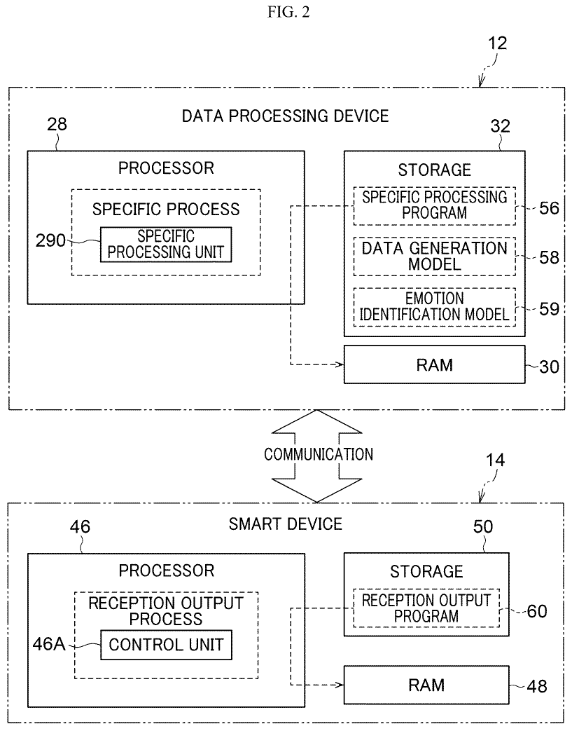

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In large-scale online and hybrid meetings, conventional computing systems that merely record audio or generate simple transcripts suffer from several technical limitations. First, a typical speech recognition pipeline produces an unstructured, time-ordered sequence of text data that is not organized by topic or by importance. As the volume of transcript data increases, conventional systems require significant processor and memory resources to search, interpret, and summarize the content, which leads to increased latency and resource consumption on general-purpose computing hardware.

Second, existing systems generally do not coordinate multiple stages of natural language processing in a systematic and machine-controlled manner. For example, conventional systems do not dynamically generate and manage different types of prompt sentences for a generative AI model depending on the processing objective, such as extracting key points, deriving action items, or detecting off-topic drift. As a result, analysis steps are often manually configured or executed, which leads to inconsistent processing, reduced automation, and increased computational overhead due to redundant or poorly scoped queries to AI services.

Third, typical meeting support tools do not incorporate real-time topic analysis into the user interface logic of participant terminals. In particular, conventional systems do not use the result of topic analysis to automatically determine, in near real time, whether an ongoing conversation has deviated from a predefined agenda and to trigger context-aware notifications on distributed terminals. This lack of integrated control flow between server-side analysis and client-side feedback prevents the system from providing timely guidance to users, thereby reducing the effectiveness of the meeting and requiring users to repeatedly scan long transcripts or logs.

Fourth, the generation of a final meeting report is often performed manually or by post-processing whole transcripts without reusing intermediate structured data. This leads to redundant computation over large text segments, higher processing cost, and increased latency for producing a final report. Additionally, conventional systems do not consistently store key points and action items as structured data during the meeting, which makes it difficult to generate machine-readable outputs that can be reliably consumed by other software systems, such as task management services.

Accordingly, there is a need for an improved computer-implemented meeting support system and server architecture that (i) organizes recognized text into time-based analysis units, (ii) systematically generates and utilizes multiple types of prompt sentences for a generative AI model, (iii) maintains and updates structured key-point and action-item data during the progress of a conference, (iv) automatically detects off-topic conversation based on agenda information, and (v) generates and distributes an integrated electronic document as a final report. By reconfiguring how a processor orchestrates speech recognition, generative AI model interaction, data structuring, and terminal notification, the invention aims to improve the technical operation of the meeting support system itself, reducing resource usage, improving response time, and enhancing the reliability and consistency of the generated outputs.

The specific processing by the specific processing unit 290 of the data processing device 12 in Example 1 is realized by the following means.

The present invention provides a server comprising a processor and a memory storing instructions that, when executed by the processor, cause the processor to acquire audio information from one or more input devices, convert the audio information into character information by using a speech recognition technique, aggregate the character information into analysis units for respective predetermined time ranges based on time information, generate for each analysis unit a prompt sentence for inputting the aggregated character information into a generative AI model, input the prompt sentence and the aggregated character information into the generative AI model to analyze topics and extract key points on the basis of natural language processing, store the extracted key points as structured data for each topic in a recording medium and sequentially update the structured data while a conference is in progress, determine, on the basis of an analysis result of the topics and agenda information of the conference, whether a conversation has deviated from a main subject, output, when it is determined that the conversation has deviated from the main subject, notification information including a humorous warning message to a terminal device of a participant, and generate, at an end of the conference, report information obtained by integrating the structured key points and information of action items based on the key points and output and share the report information as an electronic document. This enables the server to control, as a unified computational workflow, audio-to-text conversion, time-based aggregation, multi-stage interaction with a generative AI model via different prompt sentences, real-time structuring and updating of key-point and action-item data, automated detection of off-topic conversation, and automatic generation and distribution of a final electronic report, thereby improving the efficiency, scalability, and consistency of computer-based meeting analysis and support.

The term “audio information” refers to information representing sound signals acquired during a conference, including analog or digital representations of human speech captured by one or more input devices.

The term “character information” refers to text data obtained by converting audio information into a sequence of characters or words using a speech recognition technique.

The term “speech recognition technique” refers to a computer-implemented technique that analyzes audio information and generates corresponding character information, including methods that use acoustic models, language models, or machine learning models.

The term “time information” refers to information indicating a temporal position or duration associated with audio information or character information, including timestamps, start times, end times, and time intervals.

The term “predetermined time range” refers to a time interval defined in advance or dynamically by the system, used as a unit for aggregating character information for analysis.

The term “analysis unit” refers to a portion of character information that has been aggregated according to a predetermined time range and is processed together as a single input to a generative AI model.

The term “prompt sentence” refers to text data that specifies instructions, questions, or constraints for a generative AI model and is used to control how the generative AI model analyzes or generates information based on input data.

The term “generative AI model” refers to a computer-implemented artificial intelligence model that processes natural language input and generates natural language output or structured output, including models that perform topic analysis, summarization, extraction of key points, extraction of action items, or classification of conversation state.

The term “natural language processing” refers to a set of computer-implemented techniques for analyzing, interpreting, or generating human language, including tokenization, parsing, semantic analysis, summarization, and classification.

The term “topic” refers to a semantic category or subject matter identified from character information, representing a main theme or sub-theme of a conversation in a conference.

The term “key point” refers to an item of information that is determined to be important within a topic, including decisions, issues, risks, requirements, or conclusions extracted from character information.

The term “structured data” refers to data that is organized in a predefined format with explicit fields or attributes, such as a record including a topic identifier, key point text, and associated time information.

The term “recording medium” refers to any physical or virtual data storage resource used to store structured data, including semiconductor memory, magnetic storage, optical storage, or network-based storage.

The term “conference” refers to a session in which two or more participants communicate by speaking or otherwise exchanging information, including in-person, online, and hybrid meetings.

The term “agenda information” refers to information that defines one or more planned topics, items, or objectives of a conference, and is used as a reference to determine whether a conversation is on-topic or off-topic.

The term “main subject” refers to a topic or set of topics that correspond to the agenda information of a conference and represent the intended focus of the conversation.

The term “conversation has deviated from a main subject” refers to a state in which the content of character information for a current analysis unit does not correspond to or is not relevant to the agenda information defining the main subject.

The term “determination result” refers to data representing the outcome of a process that judges whether a conversation has deviated from a main subject, including a binary indication, multi-level indication, or explanation of the judgment.

The term “terminal device” refers to an information processing device operated by a participant, including a mobile device, a personal computer, a tablet, or any other user interface device capable of displaying or outputting notification information.

The term “notification information” refers to information transmitted from the server to a terminal device to inform a user of a system state or event, including text, icons, audio messages, or other representations.

The term “humorous warning message” refers to notification information that is configured to alert a participant that a conversation has deviated from a main subject while using wording or style intended to be light-hearted or amusing.

The term “participant” refers to a human user who takes part in a conference and interacts directly or indirectly with the system.

The term “action item” refers to a task, activity, or follow-up operation that is derived from key points identified in a conference and is to be executed after or during the conference.

The term “report information” refers to information that summarizes or consolidates structured key points, action items, and optional additional content into a form suitable for presentation as a final outcome of a conference.

The term “electronic document” refers to a machine-readable file containing report information, including a text file, a portable document format file, a markup file, or another digital document format.

The term “electronic document file” refers to a specific instance of an electronic document stored in a recording medium and capable of being transmitted, opened, and displayed on one or more terminal devices.

The term “share” refers to the act of distributing or making accessible electronic document files or report information to multiple participants via a communication network, including sending by electronic mail or providing access links.

The term “different types of analysis results” refers to analysis outputs obtained from a generative AI model by using different prompt sentences, such as outputs for key point extraction, outputs for action item extraction, and outputs for determination of topic deviation.

The term “first prompt sentence” refers to a prompt sentence configured to cause a generative AI model to output key points extracted from character information as summary information.

The term “second prompt sentence” refers to a prompt sentence configured to cause a generative AI model to extract action items from key points.

The term “third prompt sentence” refers to a prompt sentence configured to cause a generative AI model to determine whether a conversation has deviated from a main subject.

The term “summary information” refers to condensed information that represents the essence of character information or key points in a shorter form while preserving important content.

The term “summary sentence” refers to a textual representation of summary information that describes, in natural language, an overview of a conference, including at least decided matters and unresolved matters.

The term “decided matters” refers to decisions or conclusions that are reached and agreed upon by participants during a conference.

The term “unresolved matters” refers to issues, questions, or topics discussed during a conference that have not yet been decided or finalized.

The term “outline of the entire conference” refers to a high-level description of major topics, phases, and outcomes of a conference as expressed in one or more summary sentences.

The term “distribute” refers to providing an electronic document file, including a summary sentence and action items, to participants by transmitting the file or providing a location from which the file can be retrieved.

In one embodiment, a server, a plurality of terminals, and one or more users cooperate to implement the invention. The server includes at least one processor, a main memory, a non-volatile storage device, a network interface, and an audio interface. The server executes an operating system, such as a general-purpose server operating system, and one or more application programs implementing the meeting support functions described in the claims. The terminals include computing devices such as notebook computers, tablet devices, or smartphones, each having a display unit, a user input unit, a microphone, a speaker, and a communication interface.

The user operates the terminal to initiate a conference session. The server maintains conference management data in a structured data store, such as a relational database. The server stores for each conference one or more records including, for example, a conference identifier, agenda information, participant identifiers, start time, end time, and status flags. The server associates all subsequent audio information, character information, key points, action items, and report information with the conference identifier, thereby enabling efficient indexing and retrieval.

The server acquires audio information from at least one microphone connected to a terminal or a dedicated conference device. The server uses an audio capture module implemented in a programming language such as C++ or a scripting language and interacts with an audio driver stack provided by the operating system. The server controls sampling parameters such as sampling rate, bit depth, and channel configuration and converts analog speech signals into digital audio frames. The server groups successive audio frames into fixed-size or variable-size buffers and stores them temporarily in a ring buffer structure in main memory to reduce input/output overhead.

The server converts the audio information into character information by using a speech recognition technique. In one example, the server uses a speech recognition engine that implements a deep neural network acoustic model and a language model. The server transmits segments of the digital audio frames to a local speech recognition engine or to a remote recognition service via a network protocol. The server receives recognition results as text sequences with corresponding time information and confidence scores. The server stores the character information in a transcript table of the database, where each row contains a conference identifier, a segment start time, a segment end time, a recognized text field, and a confidence value. By maintaining explicit time information and a normalized text field, the server can later aggregate the character information efficiently.

The server aggregates the character information into analysis units for respective predetermined time ranges. The server uses time information as an index and groups the transcript entries into blocks corresponding to, for example, thirty-second or one-minute windows. The server can adjust the predetermined time range dynamically based on system load, conference length, or text volume. The server constructs for each analysis unit a text string by concatenating the recognized text fields in chronological order and preserving delimiters that represent speaker changes or pauses. The server thereby generates a compact but context-preserving unit of character information suitable for analysis by a generative AI model.

The server generates a prompt sentence for each analysis unit. The server constructs the prompt sentence by combining a static instruction template, conference-specific metadata, and the aggregated character information. In one embodiment, the server generates a first type of prompt sentence for key point extraction in the following form:

“You are a meeting assistant. From the following transcript segment, extract the main topics and key points. Group the key points by topic and focus on decisions, open issues, and risks. Transcript: [aggregated character information].”

The server generates a second type of prompt sentence for action item extraction, for example:

“From the following meeting key points, extract concrete action items. For each action item, include the task description, the responsible person if mentioned, and the deadline if mentioned. Key points: [key point list].”

The server generates a third type of prompt sentence for topic deviation detection, for example:

“Agenda of the meeting: [agenda information]. Recent conversation: [aggregated character information]. Determine whether the conversation is on-topic or off-topic with respect to the agenda. Answer with ‘ON_TOPIC’ or ‘OFF_TOPIC’ and provide a one-sentence explanation.”

The server inputs the prompt sentence and the aggregated character information into a generative AI model. In one embodiment, the generative AI model is implemented as a transformer-based neural network having multiple self-attention layers, feed-forward layers, and layer normalization components. The generative AI model is characterized by parameters including a vocabulary embedding matrix, positional encoding parameters, attention weight matrices, and feed-forward network weights. The generative AI model executes on a specialized accelerator, such as a graphics processing unit, or on a multi-core central processing unit, thereby enabling parallel processing of tokens.

The server configures the generative AI model with tokenization rules that map character sequences into token identifiers and maintains a fixed maximum context length, for example 4096 tokens. The server controls model parameters such as temperature, top-k, and top-p during inference to balance determinism and diversity in the output. The server uses a deterministic decoding strategy, such as greedy decoding or beam search with a fixed beam width, when consistent outputs are required, for example for structured key point extraction.

The server causes the generative AI model to output key points by embedding both the prompt sentence and the aggregated character information into a token sequence. The generative AI model computes, for each layer, a series of matrix multiplications and non-linear transformations over the token sequence, and produces a probability distribution over possible next tokens at each position. By constraining the model with the prompt sentence content, the server directs the generative AI model to emit text that enumerates topics and key points in a structured manner. The server receives the output text and parses markers such as bullet symbols, headings, or label keywords to generate a normalized internal structure. The server stores the extracted key points in a key point table with fields including conference identifier, topic label, key point text, associated time range, and confidence or importance score.

The server uses the same generative AI model or a different generative AI model to derive action items. The server constructs an input string that concatenates previously stored key points and the second type of prompt sentence. The generative AI model uses contextual attention to identify phrases that contain obligations, requests, or future-oriented verbs. The server parses the generated output to identify segments that match patterns for action descriptions, responsible persons, and due dates. The server normalizes these segments into a structured action item record, with fields such as task description, optional participant identifier, optional due date, and reference to the originating key point. The server stores the action items in a dedicated action item table in the database.

The server determines whether the conversation has deviated from a main subject by processing the third type of prompt sentence. The generative AI model receives the agenda information and the aggregated character information together and computes semantic similarity and relevance internally as part of its transformer architecture. The server interprets the generated “ON_TOPIC” or “OFF_TOPIC” indication and associated explanation. The server stores this determination result in a topic deviation table, with fields including conference identifier, time range, on/off-topic flag, and explanation text. By maintaining explicit records of topic deviation, the server can later analyze patterns of discussion drift and also support adaptive system behavior.

The server sends notification information to each terminal when a deviation is detected. The server constructs a message payload containing a humorous warning message, such as “Let's talk about movies after the meeting!” or “You have entered the off-topic zone. Please return to the agenda.” The server transmits the payload using a push protocol, such as a web socket connection or an event-based notification service. The terminal receives the payload through its communication interface.

The terminal displays the humorous warning message to the user. The terminal executes an application that listens for notification information and renders a user interface component, such as a banner or pop-up. The terminal vibrates, plays a distinctive sound, or changes the color of a status indicator when the warning is displayed. By controlling the hardware of the terminal in real time, the system provides immediate feedback to the user that is synchronized with the detected topic deviation.

The server maintains structured data for key points and action items throughout the conference. The server updates the key point table and action item table incrementally as new analysis units are processed. The server uses indexing on conference identifier and time ranges to support efficient queries and aggregation operations. The server reduces redundant processing by reusing existing structured records when generating the final report instead of reprocessing the entire transcript. This design decreases computational load on the generative AI model, reduces network traffic when a remote model is used, and shortens the time needed to generate a comprehensive summary.

The server generates report information at the end of the conference by integrating the structured key points and the action item information. In one embodiment, the server requests the generative AI model to generate a high-level summary sentence set using a prompt sentence such as:

“Generate a concise meeting summary from the following key points and action items. The summary should include an overview of the entire conference, the main decided matters, and unresolved matters. Key points: [key point list]. Action items: [action item list].”

The generative AI model outputs one or more paragraphs that describe the outline of the entire conference, major decisions, and pending issues. The server combines this summary with a formatted list of action items and with additional metadata such as conference title, date, and participant list. The server uses a document formatting engine to convert this information into an electronic document, for example a portable document format file. The server stores the electronic document in non-volatile storage and associates it with the conference identifier, and then transmits the document or a link to the document to the terminals of the participants.

The user accesses the generated electronic document from the terminal. The terminal downloads the document over the network and presents it using a document viewer. The user can view the summary sentences, verify the action items, and export the action items into other applications if desired.

The server improves computer technology in several ways. By aggregating character information into fixed-size analysis units and by storing intermediate structured representations of key points and action items, the server reduces the amount of data that must be repeatedly processed by the generative AI model. This structure reduces computation time and memory usage because the generative AI model is invoked on smaller, well-defined subsets of the transcript instead of on entire long transcripts. The server also reduces communication load when the generative AI model is hosted remotely, because the server transmits only aggregated analysis units and necessary prompt sentences, rather than entire raw transcripts.

The server improves accuracy and consistency of topic analysis by using distinct prompt sentences for different analysis objectives. The generative AI model is guided to produce outputs that adhere to expected formats, which simplifies parsing on the server side and reduces errors due to ambiguous outputs. This modular prompt sentence design allows the server to tune inputs for different tasks—key point extraction, action item extraction, and topic deviation detection—thereby achieving technically improved performance in terms of classification accuracy and extraction precision compared to a single undifferentiated query.

The server employs a specific generative AI model architecture, such as a transformer network trained by gradient-based optimization with a loss function that includes cross-entropy between predicted tokens and ground-truth tokens. The generative AI model is pre-trained on large corpora of natural language text and can be fine-tuned on meeting-specific data. During training, the model updates its weight parameters by backpropagating gradients and applying an optimizer, such as stochastic gradient descent with adaptive learning rate. The server can incorporate data augmentation techniques, such as shuffling sentence orders or injecting synthetic meeting dialogues, to increase robustness. By disclosing these architectural and training details, the system is not limited to an abstract “AI” concept but rather specifies concrete computational structures and learning techniques.

The server executes non-conventional processing sequences that differ from simple automation of human summarization. For example, the server enforces a rule-based post-processing step after model inference, in which the server discards key points that do not include verbs, merges overlapping action items referring to the same task, and normalizes date expressions into canonical timestamp fields. The server applies a heuristic algorithm that uses both model output and deterministic string matching to assign action items to participants, even when names are mentioned only once in a segment and then referred to by pronouns. These rule-based operations constitute specific, machine-oriented procedures that are not merely a computer implementation of human reasoning.

The server can be implemented in multiple alternative embodiments. In one variation, the server runs the generative AI model locally on a hardware accelerator. In another variation, the server accesses a remote generative AI service via a secure network connection. In yet another variation, the server uses a smaller generative AI model for real-time topic deviation detection and a larger model for post-conference summarization. The terminals can be configured as thin clients that only display notifications and reports, or as thick clients that perform some local preprocessing, such as local audio denoising or partial speech recognition. The database structure can be implemented as a relational database or as a document-oriented store, provided that the server maintains explicit fields for conference identifiers, time information, topics, key points, and action items.

By integrating these components into a coordinated architecture, the server controls the flow of data from raw audio acquisition, through time-based character aggregation and structured analysis using a generative AI model with carefully designed prompt sentences, to terminal-based feedback and final document generation. This integrated design yields technical effects including reduced latency in generating meaningful feedback, improved scalability across many simultaneous conferences, improved accuracy in detecting off-topic discussion, and more efficient storage and retrieval of structured conference information.

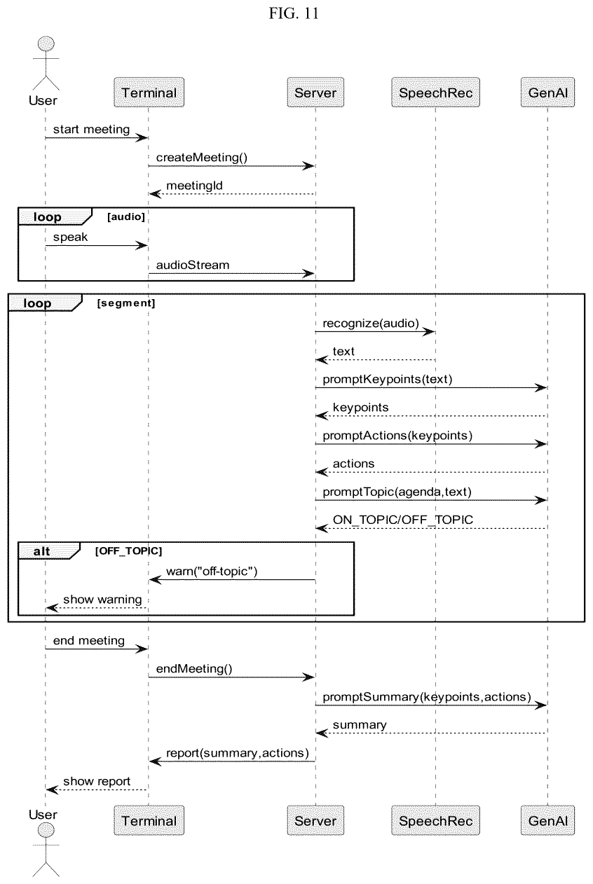

The following describes the processing flow using FIG. 11.

Step 1:

The user operates the terminal to start a conference. The input is user-specified information including a conference title, agenda text, and a list of participants. The terminal sends this information as a start request to the server. The server receives the request, allocates a new conference identifier, initializes status flags, and stores a conference record in a database. The output is a stored conference record and a session token that the server returns to the terminal.

Step 2:

The terminal begins sending audio information to the server. The input is analog speech signals captured by one or more microphones of the terminal or a connected conference device. The terminal converts the analog signals into digital audio frames using an audio codec and transmits the frames to the server over a network connection. The server receives the digital audio frames and writes them into a memory buffer. The output is a continuous stream of buffered audio data associated with the conference identifier.

Step 3:

The server segments and stores the audio information. The input is the buffered digital audio stream indexed by time. The server groups contiguous audio frames into segments of a predetermined duration, for example thirty seconds, and attaches a start time and end time to each segment. The server may compress or encode the segments into an audio file format and store segment metadata in the database. The output is a set of time-stamped audio segments each linked to the conference identifier.

Step 4:

The server converts audio segments into character information using a speech recognition technique. The input is one audio segment containing digital audio data and its time information. The server sends the audio data to a speech recognition engine and receives recognized text and confidence scores. The server then constructs a transcript record with fields such as conference identifier, segment times, recognized text, and confidence, and stores this record in a transcript table. The output is character information stored as one or more transcript entries in the database.

Step 5:

The server aggregates character information into analysis units. The input is a set of transcript entries for a continuous time range, such as the last two minutes of the conference. The server retrieves the entries from the transcript table using the conference identifier and time constraints, sorts them by start time, and concatenates the recognized text fields into a single text block. The server also records the combined time range of the text block. The output is an aggregated character information block and its associated time interval, which together form one analysis unit.

Step 6:

The server generates a first prompt sentence for key point extraction. The input is the aggregated character information block and conference metadata such as agenda text. The server inserts the aggregated text into a pre-defined instruction template and appends the agenda if needed. For example, the server generates a prompt sentence such as: “You are a meeting assistant. From the following transcript segment, extract the main topics and key points. Group the key points by topic and focus on decisions, open issues, and risks. Transcript: [aggregated character information].” The server stores this prompt text alongside the analysis unit. The output is a complete first prompt sentence ready for input to a generative AI model.

Step 7:

The server inputs the first prompt sentence and aggregated character information into a generative AI model to extract key points. The input is a token sequence representing the first prompt sentence and the aggregated text. The server tokenizes the text, feeds the token sequence to the generative AI model, and executes inference. The generative AI model computes attention weights and layer-wise transformations to infer the most probable output tokens corresponding to topics and key points. The server decodes the output tokens into text, then parses the text to identify topic labels and bullet-style key point sentences. The output is a structured set of key point data including topic, key point text, and time range that the server stores in a key point table.

Step 8:

The server generates a second prompt sentence for action item extraction. The input is the set of key point data associated with the current analysis unit. The server converts the key points into a textual list and merges this list into an action-oriented instruction template. For example, the server generates a prompt sentence such as: “From the following meeting key points, extract concrete action items. For each action item, include the task description, the responsible person if mentioned, and the deadline if mentioned. Key points: [key point list].” The output is a second prompt sentence linked to the corresponding key point set.

Step 9:

The server inputs the second prompt sentence into the generative AI model to derive action items. The input is a tokenized sequence of the second prompt sentence containing the key point list. The server causes the generative AI model to perform inference and generate one or more sentences describing tasks, assignees, and due dates. The server parses the generated text using predefined patterns and rules to identify segments that correspond to task descriptions, person names, and temporal expressions. The server normalizes names and converts date expressions into machine-readable timestamps where possible. The output is a list of structured action item records that the server stores in an action item table with references to the originating key points.

Step 10:

The server generates a third prompt sentence for topic deviation detection. The input is the aggregated character information block and the stored agenda information for the conference. The server composes a detection instruction such as: “Agenda of the meeting: [agenda information]. Recent conversation: [aggregated character information]. Determine whether the conversation is on-topic or off-topic with respect to the agenda. Answer with ‘ON_TOPIC’ or ‘OFF_TOPIC’ and provide a one-sentence explanation.” The server stores the constructed text as the third prompt sentence. The output is the third prompt sentence configured for classification of topic deviation.

Step 11:

The server inputs the third prompt sentence into the generative AI model to determine on-topic or off-topic status. The input is the tokenized third prompt sentence. The server invokes the generative AI model, which evaluates semantic relationships between the agenda text and the recent conversation portion as encoded in the token embeddings and attention mechanism. The model outputs a short classification response, for example “OFF_TOPIC—The participants are discussing movies, which are not part of the agenda.” The server parses the response to extract the on/off-topic label and the explanation. The output is a determination result that the server stores in a topic deviation record associated with the corresponding time range.

Step 12:

The server decides whether to notify the terminals based on the determination result. The input is the on/off-topic label from the topic deviation record. If the label indicates that the conversation is off-topic, the server constructs notification information including a humorous warning message, such as “Let's talk about movies after the meeting!” The server packages this text along with metadata such as the conference identifier and a timestamp into a notification payload. The output is a notification payload ready to be transmitted to each terminal registered for the conference.

Step 13:

The terminal receives and displays the humorous warning message. The input is the notification payload transmitted from the server via a push channel or a polling request. The terminal's meeting application parses the payload to obtain the message text and any display parameters. The terminal then renders a visual component, such as a pop-up dialogue or banner, containing the humorous warning message, and may activate haptic feedback or sound to draw user attention. The output is a user interface event that alerts the user in real time that the conversation has deviated from the main subject.

Step 14:

The server accumulates and updates structured key points and action items during the conference. The input is new key point data and new action item data produced by repeated execution of Steps 7 and 9 for subsequent analysis units. The server merges new key points with existing records by comparing topic labels and time ranges, and can update or consolidate key points that describe the same subject. The server also updates action items when later segments add more details or modify deadlines. The output is a continuously updated database of structured key point records and action item records covering the entire course of the conference.

Step 15:

The server generates a final summary and report information at the end of the conference. The input is the complete set of structured key point data, the full list of action items, and optional transcript excerpts. The server may construct a summary-oriented prompt sentence, for example:

“Generate a concise meeting summary from the following key points and action items. The summary should include an overview of the entire conference, the main decided matters, and unresolved matters. Key points: [key point list]. Action items: [action item list].” The server provides this prompt to the generative AI model, receives paragraphs of summary text, and combines them with the action item list and conference metadata. The output is report information that includes a summary section and an action item section.

Step 16:

The server formats and distributes the electronic document to the terminals. The input is the report information produced in Step 15. The server feeds the report text and structured items into a document generation module that creates an electronic document file, such as a formatted PDF. The server stores the file in persistent storage and associates it with the conference identifier. The server then transmits the file itself or a URL referencing the file to the terminals of the participants via electronic mail or a messaging protocol. The terminal receives the file or link, and the user opens the document on the terminal to review the conference summary and the action items. The output is a delivered electronic document accessible to all participants.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented meeting support systems primarily focus on recording speech and converting the speech into text, and may further provide simple keyword extraction or fixed-format summaries. However, such systems treat the transcript as a passive log and do not actively control or optimize the flow of the meeting in real time. As a result, when participants digress from the intended topic, the system does not intervene, and the efficiency and consistency of meeting outcomes depend heavily on human facilitation. Moreover, existing systems generally rely on static rule-based logic for identifying key points and action items, which lacks robustness against varied natural language expressions and complex, dynamic discussion patterns.

From the perspective of computer technology, this leads to several technical problems. First, the processing pipeline from audio acquisition to meeting analysis is fragmented: speech recognition, natural language processing, and any downstream analytics are often implemented as isolated modules without a unified control mechanism. This fragmentation prevents the system from adaptively reusing intermediate analysis results, such as utterance segmentation or extracted key points, to improve subsequent processing steps. Second, conventional systems do not leverage generative artificial intelligence models in a structured way. When generative models are used at all, they are typically called with ad hoc input text, without a carefully engineered prompt structure that encodes meeting objectives, temporal context, and control instructions. Consequently, the output quality, determinism, and reproducibility of the generative model's behavior are inadequate for reliable, real-time meeting control.

Third, existing systems do not tightly integrate topic-conformity detection and interactive feedback generation into the core control flow of the computer system. Topic drift is usually left to human judgment, and any warnings or guidance are either non-existent or based on simple keyword matching, which is insensitive to semantic context. This results in inefficient use of computational resources, because the system continuously processes audio and text without closing the loop back to the user interface in a semantically meaningful way. Fourth, most systems do not transform meeting analysis results into structured, machine-actionable data objects that can be automatically registered in external task or workflow management services. This lack of structured integration forces human users to manually re-enter action items into other systems, leading to duplication, errors, and latency in operational workflows.

Accordingly, there is a need for an improved computer-implemented system that provides an integrated, processor-controlled pipeline from audio capture through speech recognition, temporal segmentation, natural language analysis, prompt-based interaction with a generative artificial intelligence model, topic-conformity determination, humorous warning generation, and structured meeting summary and action item creation. There is also a need for a system that treats prompt sentences as first-class control artifacts, allowing the processor to systematically encode task instructions, meeting objectives, and recent utterance context into prompts in order to obtain predictable and context-appropriate outputs from the generative model. Furthermore, there is a need for a system that automatically converts the structured summary and action item information into task data suitable for registration in external work management services via a communication network, thereby improving overall computer system efficiency, data consistency, and automation of downstream workflows.

The specific processing by the specific processing unit 290 of the data processing device 12 in Application Example 1 is realized by the following means.

The present invention provides a server comprising a processor configured to acquire audio information, convert the audio information into character information by using a speech recognition technique, store the character information and segment the character information into a plurality of utterance sections on the basis of time information, analyze grammatical structure and semantic information of each utterance section by using a natural language processing technique and extract meeting key points and action item candidates, generate a prompt sentence for a generative artificial intelligence model on the basis of meeting objective information and the character information including the utterance sections, input the prompt sentence into the generative artificial intelligence model and cause the generative artificial intelligence model to determine whether a topic of the utterance sections conforms to the meeting objective, generate, when the topic is determined to deviate from the meeting objective, a prompt sentence for causing the generative artificial intelligence model to generate a humorous warning message according to content of the deviation and the meeting objective information and acquire the humorous warning message from the generative artificial intelligence model, record the extracted meeting key points and the action item candidates as structured information, generate meeting summary information and action item information on the basis of the structured information and a response obtained from the generative artificial intelligence model, convert the meeting summary information and the action item information into task information compatible with a work management service provided by an external information processing device, register the task information in the work management service via a communication network, and present at least the meeting summary information, the action item information, and the humorous warning message to meeting participants via an information terminal device. This enables an integrated computer-implemented pipeline in which audio signals are transformed into semantically structured and machine-actionable data, in which prompt sentences are systematically constructed as control inputs to a generative artificial intelligence model for both topic-conformity determination and humorous feedback generation, and in which the server automatically propagates the structured meeting outcomes into external work management services, thereby improving processing efficiency, robustness of natural language understanding, real-time meeting control, and end-to-end automation in a multi-component computer system.

The term “audio information” refers to time-series data representing sound signals acquired by a sensor, such as a microphone, suitable for digital processing by an information processing apparatus.

The term “character information” refers to textual data obtained by converting audio information into a sequence of characters or symbols that represent spoken content in a natural language.

The term “speech recognition technique” refers to a computational procedure that analyzes audio information and outputs corresponding character information by using one or more acoustic models, language models, or pattern recognition algorithms.

The term “time information” refers to data indicating temporal positions or intervals associated with audio information or character information, including timestamps, durations, or sequence indices used for segmentation or alignment.

The term “utterance section” refers to a unit of character information segmented on the basis of time information and corresponding to one or more continuous spoken statements in a conversation.

The term “natural language processing technique” refers to a computational procedure that analyzes character information written in a natural language to determine linguistic features such as token boundaries, part-of-speech categories, syntactic structure, semantic relations, or named entities.

The term “grammatical structure” refers to syntactic relations among words or phrases in character information, including dependencies, phrase boundaries, and sentence-level organization, as determined by a natural language processing technique.

The term “semantic information” refers to meaning-related features extracted from character information, including topics, roles, intents, relationships among entities, and other conceptual attributes derived by a natural language processing technique.

The term “meeting key points” refers to pieces of character information that summarize essential content of a meeting, including decisions, confirmed facts, or important discussion results identified by analysis of utterance sections.

The term “action item candidates” refers to pieces of character information representing potential tasks, obligations, or follow-up operations implied or explicitly stated during a meeting and extracted from utterance sections.

The term “meeting objective information” refers to data describing an intended purpose, agenda, scope, or target topics of a meeting, used as a reference to evaluate conformity of discussion content.

The term “generative artificial intelligence model” refers to a trained computational model that receives input data including a prompt sentence and produces output data such as text, classifications, or messages by generating new content according to learned patterns.

The term “prompt sentence” refers to character information supplied as input to a generative artificial intelligence model, the character information including instructions, context, or examples that condition behavior of the generative artificial intelligence model.

The term “topic of the utterance sections” refers to a semantic subject matter or theme discussed within one or more utterance sections, as determined by analysis of character information.

The term “topic conforms to the meeting objective” refers to a state in which the topic of the utterance sections is relevant to, consistent with, or within a scope defined by the meeting objective information.

The term “deviate from the meeting objective” refers to a state in which the topic of the utterance sections is determined to be irrelevant to, inconsistent with, or outside a scope defined by the meeting objective information.

The term “humorous warning message” refers to character information that notifies meeting participants of topic deviation in a polite and light-hearted manner while encouraging a return to the meeting objective.

The term “structured information” refers to data formatted according to a predetermined schema, such as records or fields, enabling systematic storage, retrieval, and processing by an information processing apparatus.

The term “meeting summary information” refers to structured information that condenses and describes overall content of a meeting, including key points and outcomes derived from analysis of utterance sections and responses from a generative artificial intelligence model.

The term “action item information” refers to structured information specifying tasks derived from action item candidates, the structured information including at least a description of a task and optionally associated attributes such as responsible persons or due dates.

The term “task information” refers to structured information formatted for registration in a work management service, the structured information representing a unit of work derived from action item information.

The term “work management service” refers to a service executed by an external information processing device that manages tasks, workflows, or schedules, and that provides an interface for registering, updating, and viewing task information via a communication network.

The term “external information processing device” refers to a computing apparatus located outside a server implementing the invention, the computing apparatus executing at least the work management service and communicating with the server via a communication network.

The term “communication network” refers to an infrastructure that enables data exchange between the server, information terminal devices, and external information processing devices, and includes at least one of a local area network, a wide area network, or a wireless network.

The term “information terminal device” refers to a user-operable computing apparatus, such as a portable terminal or desktop terminal, configured to communicate with the server and present meeting summary information, action item information, or humorous warning messages to a user.

In one embodiment, a server implements the claimed system as a meeting-support platform deployed in a networked environment such as a factory, office, or conference facility. The server executes on a general-purpose computing device that includes at least one multi-core processor, a main memory, a non-volatile storage device, and a network interface. The server communicates with one or more terminals operated by users and with one or more external information processing devices over a communication network such as an Ethernet-based local area network or a wireless network.

The server uses an operating system such as a UNIX-like operating system and application software implemented, for example, in a high-level programming language such as Python or Java. The server includes software modules for audio acquisition, speech recognition interaction, natural language processing, prompt sentence generation, generative AI model interaction, topic-conformity determination, humorous message generation, structured data storage, summary generation, and external task service integration. The server stores persistent data such as transcripts, key points, and action items in a relational database management system, for example a database engine compatible with SQL.

The server acquires audio information from microphones installed in a meeting room. The microphones may be integrated into a dedicated audio capture device or into a terminal. The server receives audio streams via a network using a streaming protocol and converts the audio into a standardized format such as 16 kHz, 16-bit linear PCM. The server uses an audio capture library such as PortAudio to manage audio buffers in main memory. By using fixed-size audio frames and buffering policies, the server reduces jitter and avoids buffer underrun, thereby improving the stability of audio acquisition.

The server converts the audio information into character information by using a speech recognition technique. In one embodiment, the server accesses a cloud-based speech recognition service through an application programming interface. In another embodiment, the server executes an on-premise speech recognition engine that implements acoustic models and language models using deep neural networks. The acoustic model may be a convolutional neural network or a recurrent neural network that maps spectrogram features to phonetic units. The language model may be an n-gram model or a transformer-based model that predicts probable word sequences. The server supplies audio frames and configuration parameters, such as language code and sampling rate, to the speech recognition engine and receives recognized text and time-aligned word boundaries. The server stores the recognized character information and the time information as records in the database, thereby enabling later alignment and segmentation.

The server segments the character information into utterance sections on the basis of time information. In one embodiment, the server groups consecutive words into sentence-level units using punctuation inferred by the speech recognition engine and merge thresholds based on inter-word time gaps. For example, when a pause exceeds a configurable time, the server starts a new utterance section. The server stores each utterance section in the database with a unique identifier, start time, end time, and text field. This segmentation into utterance sections reduces the computational cost of downstream analysis, because the server processes only the most recent segments instead of the entire transcript.

The server analyzes grammatical structure and semantic information of each utterance section by using a natural language processing technique. In one embodiment, the server loads a language model such as a transformer-based or statistical model that performs tokenization, part-of-speech tagging, dependency parsing, and named entity recognition. The server converts each utterance section into a sequence of tokens with syntactic and semantic annotations. The server then applies rule sets for identifying meeting key points and action item candidates. For example, the server applies dependency patterns that match verb phrases with modal verbs such as “must,” “should,” or equivalent expressions in the target language, and participants' names or roles as subjects. The server identifies phrases that contain temporal expressions such as dates, times, or deadlines and associates them with corresponding actions. These rule sets and pattern matchers are specifically optimized for meeting-related language, which improves extraction precision compared with generic keyword-based approaches.

The server generates meeting key points and action item candidates as structured information. For each utterance section, the server creates a data structure that includes a reference to the original text, a classification label (e.g., decision, requirement, task), and extracted attributes such as responsible entity and target date when available. The server writes these structures into normalized tables in the database, which allows subsequent queries and aggregation. This structured representation, in contrast to unstructured logs, enables the server to perform efficient indexing and caching, thereby improving retrieval speed when constructing summaries or exporting tasks.

The server generates a prompt sentence for a generative AI model on the basis of meeting objective information and the character information including the utterance sections. In one embodiment, the server obtains meeting objective information from initial configuration data entered on a terminal before the meeting, such as “Work-instruction meeting for production line A, focusing on safety checks and quality control.” The server maintains a context object that contains the meeting objective, the most recent utterance sections, and a summary of past key points. When a new utterance section is completed, the server composes a prompt sentence that embeds: (i) a role instruction that defines the behavior of the generative AI model, (ii) the meeting objective information, and (iii) the text of the recent utterance sections, followed by explicit instructions to perform topic-conformity determination.

For example, the server may generate a prompt sentence in the following textual format:

“System role: You are a meeting monitoring assistant for a factory work-instruction meeting.

Meeting objective: Decide safety checks and quality criteria for production line A.

Recent transcript segment:

‘By the way, what are you planning to do this weekend? I am thinking of going fishing.’

Task:
1. Decide whether this segment is ON_TOPIC or OFF_TOPIC relative to the meeting objective.
2. Output only one of the following labels: ON_TOPIC or OFF_TOPIC.”

The server inputs this prompt sentence into a generative AI model. In one embodiment, the generative AI model is a transformer-based language model that has an encoder-decoder architecture or decoder-only architecture with multiple self-attention layers, feed-forward layers, and layer normalization. The model parameters are trained on large-scale corpora to learn statistical patterns of natural language. The server encodes the prompt sentence into token IDs and performs inference by applying matrix multiplications and non-linear activations through the layers. The model outputs a probability distribution over possible next tokens, and the server decodes the tokens into the label “ON_TOPIC” or “OFF_TOPIC.” Because the server controls the prompt content and decoding strategy, the generative AI model behaves as a deterministic classifier within the specified context.

The server causes the generative AI model to determine whether the topic of the utterance sections conforms to the meeting objective, and the server uses the result to trigger humorous feedback when needed. When the topic is determined to deviate from the meeting objective, the server generates another prompt sentence for causing the generative AI model to generate a humorous warning message according to the content of the deviation and the meeting objective information. For example, the server may generate a prompt sentence such as:
“You are an AI assistant monitoring a factory work-instruction meeting.

Meeting objective: Work-instruction meeting for production line A, focusing on safety checks and quality control.

The participants started talking about weekend leisure plans, which is off-topic.

Task: Write a short, polite, and humorous warning message (one or two sentences) that asks participants to return to the main topic. Avoid sarcasm and offensive expressions.”

The server inputs this prompt sentence into the same or a different generative AI model, obtains the generated text, and stores the humorous warning message in main memory. The server may apply a post-processing filter that checks the generated message for prohibited terms or length constraints to ensure consistent behavior across different meetings.

The server records the extracted meeting key points and action item candidates as structured information and generates meeting summary information and action item information on the basis of the structured information and responses obtained from the generative AI model. In one embodiment, the server requests a multi-part output from the generative AI model that includes a prose summary and a machine-readable list of action items. The server constructs a prompt sentence that supplies a list of extracted key points and action item candidates and instructs the generative AI model to refine them and generate a concise narrative. For example, the server may generate a prompt sentence such as:

“You are an AI assistant that summarizes factory work-instruction meetings.

Context: This meeting is about safety checks and quality control for production line A.

Key points and action item candidates:
1. Check safety interlock of machine A before start-up.
2. Assign operator training on new inspection procedure.
3. Inspect visual defects on parts before packaging.

Transcript excerpt:

[ . . . truncated Text . . . ]

Task:
1. Produce a concise summary (150-250 words) in English.
2. List all action items in bullet form, with fields: ‘Task’, ‘Responsible person’ (if mentioned), and ‘Due date’ (if mentioned).
3. Use a clear, factual, and neutral tone.”

The server receives the generative AI model's output and parses the content into structured fields. The server then merges redundant items and resolves references, for example mapping a person's name mentioned in the transcript to a specific user identifier in the system. By combining rule-based extraction with generative refinement, the server improves both precision and recall, resulting in a more accurate and comprehensive summary than either method alone. This hybrid approach constitutes a technical improvement in the way the server processes unstructured meeting data.

The server converts the meeting summary information and the action item information into task information compatible with an external work management service. In one embodiment, the server defines a mapping from internal fields such as “task_title,” “description,” “assignee_id,” and “due_date” to external service fields such as “summary,” “details,” “owner,” and “deadline.” The server constructs application programming interface requests with appropriate authentication tokens and sends task creation requests over the communication network. The server receives responses that include task identifiers and stores the identifiers in the database, establishing a link between internal records and external tasks. This direct integration reduces human error and latency associated with manually copying action items, and it ensures consistency across multiple systems.

The server presents at least the meeting summary information, the action item information, and the humorous warning message to meeting participants via a terminal. In one embodiment, the terminal is a portable terminal such as a smartphone or tablet executing a client application. The terminal periodically sends synchronization requests to the server and receives JSON or similar structured responses. The terminal displays real-time transcript snippets, highlights current key points, and shows action items in a list. When the server generates a humorous warning, the terminal displays the message as a pop-up or overlay and may optionally trigger an audible alert. The terminal thus acts as an interactive interface between the server's processing pipeline and the user.

The user participates in the meeting by speaking naturally in the vicinity of the microphone and, optionally, by interacting with the terminal to enter meeting objectives, confirm action items, or end the meeting. The user does not need to operate the underlying algorithms or configure low-level parameters. The user instead perceives the system as a responsive assistant that keeps the meeting on track, documents outcomes, and registers tasks automatically.

From a technical standpoint, the described system improves computer technology in several ways. First, by segmenting character information into utterance sections with associated time information and restricting generative AI inference to relevant segments, the server reduces the amount of text processed per request, which decreases processing latency and communication load with external model-hosting services. Second, by generating prompt sentences in a structured and parameterized manner, the server converts abstract generative AI behavior into a controllable subsystem that behaves more predictably and efficiently than generic free-form text generation. Third, by combining deterministic rule-based extraction with generative refinement, the server increases the accuracy of key point and action item detection beyond that of traditional keyword search while using computational resources more efficiently than a purely generative approach applied to the full transcript.

In one embodiment, the generative AI model is a transformer neural network with multiple attention heads and a predefined number of layers. The model processes token embeddings derived from the prompt sentence and applies positional encodings to maintain order information. During training, the model minimizes a cross-entropy loss function between predicted tokens and ground truth tokens on a large corpus of text. The model parameters are updated by an optimization algorithm such as stochastic gradient descent with momentum or Adam. Data augmentation techniques, such as random masking and sentence shuffling, are used during pre-training to improve generalization. Although training may occur outside the deployed system, the structure and behavior of the model are fixed at inference time. The server exploits the model's learned association between instructions and outputs by carefully shaping the prompt sentences, thereby obtaining high-quality, task-specific responses without modifying model weights.

In another embodiment, the server uses a smaller local generative model or a different model architecture for topic-conformity determination, such as a bidirectional transformer classifier fine-tuned on labeled meeting data. The server may select between multiple models based on resource constraints or latency requirements. For example, the server may use a large remote model for summary generation, which is more tolerant of delay, and a compact local model for real-time topic-conformity checks. This flexible architecture allows the server to balance processing load and network bandwidth, further improving overall system performance.

The server also implements specific data structures and processing flows that reduce redundancy and enhance efficiency. For instance, the server maintains an in-memory cache that stores recent utterance sections, extracted features, and model outputs. When generating both a topic-conformity decision and a humorous warning for the same segment, the server reuses the same encoded representation of the utterance section, avoiding repeated natural language processing for identical text. Similarly, the server stores intermediate parse trees and entity recognition results that can be reused when constructing later prompts or summaries. This reuse of intermediate computations leads to a reduction in CPU usage and response time.

The system's behavior differs from mere automation of human note-taking because the server performs operations that are impractical for humans to execute in real time, such as continuously monitoring word-level timings, computing embeddings, and applying attention-based classification across long sequences. The server's algorithmic framework enforces a consistent pattern of topic monitoring and feedback generation across all meetings, irrespective of human facilitator skill. This consistency, achieved through structured prompt sentences and rule-based pre-processing, constitutes a technical effect that improves reliability and scalability of computer-mediated meetings.

Various alternative embodiments and modifications are possible. The server may integrate different natural language processing libraries or custom models, provided that they output grammatical and semantic annotations suitable for key point extraction. The server may use different segmentation strategies, such as acoustic energy-based segmentation or speaker diarization, to define utterance sections. The terminal may be implemented as a web application running in a browser instead of a native application. The external work management service may be any system that accepts task information through an application programming interface, including on-premise workflow systems.

In all embodiments, the server, the terminal, and the user cooperate such that audio information is transformed into character information, then into structured meeting key points, action items, and external tasks, under the control of a processor that orchestrates deterministic preprocessing, structured prompt sentence generation, and generative AI model inference. This integrated architecture and the described data processing flow provide concrete improvements in processing speed, accuracy of information extraction, consistency of meeting control, and efficiency of downstream task registration in comparison with conventional systems.

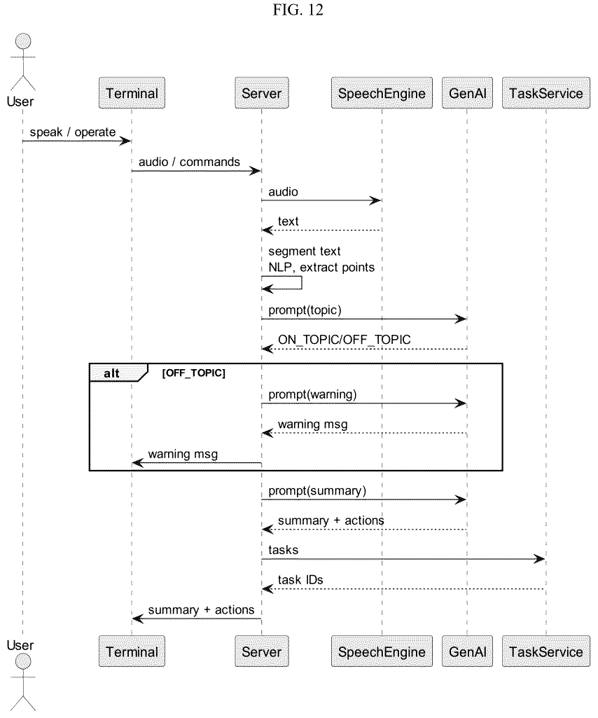

The following describes the processing flow using FIG. 12.

Step 1:
The server acquires audio input from one or more microphones.
The server receives a continuous audio stream as the input and stores the audio samples in a memory buffer in a standardized format (for example, 16 kHz, 16-bit mono PCM).
The server segments the buffered audio into fixed-length frames (for example, 1-2 seconds) and tags each frame with a timestamp as metadata.
The server outputs a sequence of time-stamped audio frames that are ready for speech recognition.

Step 2:
The server sends the time-stamped audio frames to a speech recognition engine.
The server uses the audio frames as input and applies a speech recognition technique that converts the acoustic signal into character information.
The server passes feature vectors (for example, Mel-frequency cepstral coefficients) derived from the audio to an acoustic model and applies a language model to determine the most probable word sequence.
The server outputs recognized text segments with associated start and end times for each word or phrase, forming a raw transcript.

Step 3:
The server stores the recognized text segments and their time information in a database.
The server uses the text segments with timestamps as input and groups contiguous text segments into utterance sections based on silence intervals or punctuation boundaries.
The server creates an utterance record for each section, storing fields such as meeting identifier, section identifier, start time, end time, and utterance text.
The server outputs a list of utterance sections that represent the meeting conversation in discrete units.

Step 4:
The server analyzes each utterance section using a natural language processing technique.
The server takes an utterance section as input and tokenizes the text, assigns part-of-speech tags, and constructs a dependency parse tree.
The server extracts grammatical structure and semantic information, such as subject-verb-object relations and named entities, by traversing the parse tree and applying pattern-matching rules.
The server outputs an annotated representation for each utterance section, including tokens, syntactic dependencies, entities, and semantic role labels.

Step 5:
The server identifies meeting key points based on the annotated utterance sections.
The server uses the annotated representation as input and applies rule-based filters that detect linguistic patterns indicative of decisions, requirements, or important statements (for example, sentences containing modal verbs or imperative forms).
The server scores candidate sentences by counting matched patterns and weighting terms such as obligation words or domain-specific keywords.
The server outputs a set of key point records, each containing a reference to the original utterance section and a concise label summarizing the content.

Step 6:
The server extracts action item candidates from the annotated utterance sections.
The server uses the same annotated representation as input and searches for patterns that indicate tasks, such as combinations of an agent (person or role), an action verb, and an object, optionally together with time expressions.
The server associates detected agents and deadlines with corresponding task descriptions by using coreference resolution and temporal expression recognition.
The server outputs structured action item candidate records that include task description, possible responsible party, and possible due date.

Step 7:
The server composes meeting objective information and recent utterance sections into a context object.
The server uses the stored meeting objective text and a subset of the most recent utterance sections as input and concatenates them into a single contextual description with explicit separators (for example, headers for “Objective” and “Recent transcript segment”).
The server limits the length of the context by selecting only the last N utterance sections or by truncating older content to maintain a maximum token count compatible with the generative AI model.
The server outputs a normalized context string that serves as the basis for a prompt sentence.

Step 8:
The server generates a prompt sentence for topic-conformity determination by a generative AI model.
The server uses the context string as input and wraps it with control instructions that define the role of the generative AI model and the required output format.
The server inserts explicit tasks such as “Decide whether this segment is ON_TOPIC or OFF_TOPIC” and “Output only one of the following labels” into the prompt sentence.
The server outputs a complete prompt sentence ready to be sent to the generative AI model.

Step 9:
The server sends the prompt sentence to the generative AI model and obtains a topic-conformity decision.
The server uses the prompt sentence as input and encodes it into tokens according to the model's tokenizer, then forwards the token sequence to the generative AI model via an inference API.
The server receives a sequence of output tokens from the generative AI model and decodes them into text, then parses the text to extract the classification label “ON_TOPIC” or “OFF_TOPIC.”
The server outputs a topic-conformity result associated with the corresponding utterance sections.

Step 10:
The server determines whether to generate a humorous warning message based on the topic-conformity result.
The server uses the label “ON_TOPIC” or “OFF_TOPIC” as input and compares it against a threshold condition (for example, generate warning only when OFF_TOPIC persists for more than one utterance section).
The server updates an internal state that tracks consecutive off-topic segments and decides whether immediate feedback is required to redirect the discussion.
The server outputs a decision flag indicating whether humorous warning generation should proceed.

Step 11:
The server generates a prompt sentence for humorous warning creation by the generative AI model.
The server uses the meeting objective information, a summary of the off-topic content, and the decision flag as input and builds a new prompt sentence that instructs the generative AI model to generate a short, polite, and humorous message.
The server includes constraints in the prompt, such as maximum sentence count, avoidance of offensive expressions, and the requirement to encourage a return to the main topic.
The server outputs a humorous-warning prompt sentence tailored to the current off-topic situation.

Step 12:
The server sends the humorous-warning prompt sentence to the generative AI model and acquires a humorous warning message.
The server uses the humorous-warning prompt sentence as input and performs an inference call similar to the topic-conformity determination, allowing free-form natural language output within the specified constraints.
The server decodes the output tokens into text and applies a post-processing filter to remove undesired content, enforce length limits, and normalize punctuation.
The server outputs a finalized humorous warning message string ready to be delivered to terminals.

Step 13:
The server compiles meeting summary information using both rule-based results and generative AI outputs.
The server uses the stored key point records, action item candidate records, and complete or partial transcript as input and constructs a composite prompt sentence for summary generation by the generative AI model.
The server instructs the model, via the prompt, to produce a structured summary and an explicit list of action items, while the server later cross-checks the model's list with rule-based candidates to merge duplicates and resolve conflicts.
The server outputs meeting summary information that includes a narrative summary and a cleaned, consolidated set of action items.

Step 14:
The server converts the action item information into task information compatible with an external work management service.
The server uses the consolidated action item records as input and maps internal fields (for example, “task description,” “assignee identifier,” “deadline”) to the external service's API parameters.
The server formats each task as a structured payload, attaches authentication data, and ensures that data types and field names meet the requirements of the external service.
The server outputs a batch of task payloads ready to be transmitted over a communication network.

Step 15:
The server registers the task information in the external work management service.
The server uses the task payloads as input and transmits them via HTTP or another protocol to the external information processing device that hosts the work management service.
The server receives responses that include external task identifiers and registration status codes, then records these values in the local database for traceability.
The server outputs updated task records that link internal action items to external tasks.

Step 16:
The server prepares display data for terminals.
The server uses the meeting summary information, action item information, humorous warning messages, and recent transcript sections as input and constructs a response object that groups data by display type (for example, “summary,” “action items,” “notifications,” “transcript”).

The server performs formatting operations such as truncation for long texts, sorting of action items by priority or due date, and marking newly generated warnings as unread.
The server outputs a formatted data package suitable for rendering on terminal screens.

Step 17:
The terminal requests and receives the formatted data package from the server.
The terminal uses a network request as input and sends a synchronization message or maintains a persistent connection to the server.
The terminal receives the data package, parses it into internal data structures (for example, lists or objects), and updates the user interface elements such as transcript views, summary panels, action item lists, and notification banners.
The terminal outputs an updated visual display that presents the meeting summary information, action item information, and any humorous warning messages to the user.

Step 18:
The user interacts with the terminal to review and optionally confirm the system's outputs.
The user uses the rendered display as input and reads the summary, inspects the action items, and observes any humorous warnings.
The user may tap or click on an item to view details, mark an action item as acknowledged, or indicate the end of the meeting, and the terminal sends these user actions back to the server as structured requests.
The user's interactions output updated control commands or confirmations that the server uses to finalize records and to stop or continue processing for the current meeting.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented meeting support systems primarily record audio or convert speech to text, but they do not adequately improve the operation of the computing environment itself. In particular, such systems typically: (i) treat speech recognition, text analysis, and meeting summarization as isolated processes; (ii) depend on manual configuration or post hoc human review to identify key points and action items; and (iii) lack real-time, system-level mechanisms to monitor topic deviation and adaptively guide the meeting flow. As a result, processor, memory, and network resources are often used inefficiently, and the generated meeting records are fragmented, inconsistent, or delayed.

In many existing architectures, the processor of a meeting server merely stores transcripts as unstructured text data. Subsequent processing to extract actionable information is often performed by separate tools or manual operations, which introduces redundant data transfers, repeated parsing of the same text, and duplicated computations. This fragmented processing pipeline increases latency, raises computational overhead, and degrades responsiveness when the system is deployed in a multi-user, real-time environment.

Furthermore, known systems that use artificial intelligence models for summarization generally provide only a coarse, after-the-fact summary of long transcripts. They do not use intermediate natural language processing results, such as detected topic-related expressions, action-related expressions, and off-topic expressions, to generate optimized prompt sentences for a generative artificial intelligence model. Consequently, the generative artificial intelligence model receives overly long or noisy inputs, which increases processing time, consumes more computing resources, and can reduce the accuracy and stability of the generated summaries and extracted key points.

Additionally, conventional systems provide limited or no functionality for automatically detecting when conversation content deviates from a planned meeting subject and for issuing adaptive warnings. User devices often display static notifications or rely on human moderators, rather than having the server dynamically generate audio or visual warnings based on real-time natural language analysis. This lack of integrated, automated control within the server-side processing causes inefficient use of audio synthesis resources and limits the ability of the computing system to enforce meeting discipline and maintain focused interaction.

Moreover, existing systems typically do not maintain a unified, structured record that links key points, action items, and meeting-level summaries within a single data model. Instead, partial information is stored across multiple, loosely connected data structures, which complicates retrieval, follow-up scheduling, and automated notification. This fragmented storage model leads to increased database queries, redundant joins, and unnecessary application logic on the server side, thereby degrading overall system performance.

Therefore, there is a need for an improved computer-implemented system and method that tightly integrates audio acquisition, speech recognition, natural language processing, prompt generation for a generative artificial intelligence model, structured storage of key points and action items, and real-time topic-deviation warnings. Such a system should reorganize the processing pipeline so that the server efficiently leverages intermediate analysis results, reduces redundant computation, optimizes data flow between components, and thereby improves the functioning of the underlying computer system in terms of processing efficiency, responsiveness, and quality of generated meeting information.

The specific processing by the specific processing unit 290 of the data processing device 12 in Example 2 is realized by the following means.

The present invention provides a server comprising a processor and a memory storing instructions that, when executed by the processor, cause the processor to acquire audio information representing speech of a meeting participant from a terminal device via a communication interface, convert the audio information into character information by executing a speech recognition process, analyze the character information by executing a natural language processing process to detect specific expressions including expressions related to a meeting topic, expressions indicating an action, and expressions indicating deviation from a subject, extract, from the detected specific expressions, expressions indicating key points of the meeting and expressions indicating action items, and store the extracted expressions as structured record data in a storage apparatus, generate a prompt sentence based on the character information and the detected specific expressions, the prompt sentence being configured to cause a generative artificial intelligence model to analyze a topic and to extract key points, input the prompt sentence to the generative artificial intelligence model and obtain summary information, generate meeting information including the key points and the action items based on the summary information and the structured record data, and output the meeting information to the terminal device, and generate a warning message based on a stored warning sentence when expressions indicating deviation from the subject are detected among the specific expressions and output the warning message to the terminal device by a synthesized audio process or a visual display process. This enables the server to reorganize audio, text, and semantic analysis into a single, integrated processing pipeline that reduces redundant computation, optimizes data passed to the generative artificial intelligence model, maintains a unified structured representation of key points and action items, and provides real-time, automated feedback to user devices, thereby improving the efficiency, responsiveness, and technical performance of the computer system in executing meeting support functions.

The term “audio information” refers to digital data representing sound signals, including speech uttered by a meeting participant, which is acquired from an input apparatus such as a microphone of a terminal device.

The term “input apparatus” refers to a hardware component of a terminal device that acquires physical input from a user, such as a microphone for capturing sound or a user interface device for receiving user operations, and converts the input into digital data.

The term “terminal device” refers to an electronic device operated by a user, such as a personal computer, a mobile device, or another computing apparatus, that communicates with a server or information processing apparatus via a communication network.

The term “communication protocol” refers to a set of rules and formats for exchanging data between devices over a communication network, including protocols for establishing connections, transmitting messages, and ensuring data integrity.

The term “information processing apparatus” refers to an electronic computing device, such as a server, that includes at least one processor and memory, executes programs, and performs processing on data including audio information and character information.

The term “speech recognition process” refers to a computational procedure performed by the processor that analyzes audio information and converts the audio information into text data representing recognized words or phrases.

The term “character information” refers to text data that represents linguistic content, including words, phrases, and sentences, obtained by converting audio information through a speech recognition process.

The term “natural language processing process” refers to a computational procedure for analyzing character information, including tokenization, syntactic analysis, semantic analysis, and detection of specific expressions based on linguistic rules or models.

The term “specific expressions” refers to expressions detected from the character information that satisfy predetermined conditions, including expressions related to a meeting topic, expressions indicating an action, and expressions indicating deviation from a subject.

The term “expressions related to a meeting topic” refers to specific expressions that indicate content relevant to an agenda, subject matter, or primary objective of a meeting, as determined by predefined rules or models.

The term “expressions indicating an action” refers to specific expressions that suggest tasks, operations, or activities to be performed, such as instructions, requests, or descriptions of future work.

The term “expressions indicating deviation from a subject” refers to specific expressions that indicate that the conversation content has departed from a predetermined meeting subject or agenda, as determined by comparison with topic-related criteria or off-topic patterns.

The term “key points” refers to portions of the conversation content representing important conclusions, decisions, or main ideas discussed in the meeting, which are extracted from the specific expressions.

The term “action items” refers to specific tasks or follow-up activities to be executed after or during the meeting, which are extracted from the specific expressions indicating an action.

The term “structured record data” refers to data stored in a storage apparatus in a predefined schema, including fields such as item type, textual content, identifiers, and timestamps, which represent extracted key points and action items in a machine-readable format.

The term “storage apparatus” refers to a hardware component or system, such as a memory device or database system, that stores data including structured record data, character information, and meeting information in a non-transitory manner.

The term “prompt sentence” refers to a text string generated by the information processing apparatus, configured to serve as an input to a generative artificial intelligence model and to instruct the model to perform a specific operation such as topic analysis or key point extraction.

The term “generative artificial intelligence model” refers to a machine learning model that generates output data, such as text, based on input data including a prompt sentence and character information, and that is capable of performing tasks such as summarization and key point extraction.

The term “summary information” refers to information generated by the generative artificial intelligence model that concisely represents the content of the character information, including identified topics, key points, and other salient information.

The term “meeting information” refers to information generated by the information processing apparatus based on the summary information and structured record data, including at least key points and action items for a particular meeting.

The term “output apparatus” refers to a hardware component associated with a terminal device, such as a display, a speaker, or another presentation device, that presents meeting information or warning messages to a user.

The term “warning sentence” refers to preset text data stored in the storage apparatus that defines a message to be used when a deviation from a subject is detected, such as a phrase prompting participants to return to the meeting topic.

The term “warning message” refers to information generated based on a warning sentence, which is provided to a user as an audio output, a visual output, or both, in order to notify the user that the conversation has deviated from a subject.

The term “synthesized audio process” refers to a computational procedure that converts text data, including a warning sentence, into audio data representing artificially generated speech for output through an audio apparatus.

The term “visual display process” refers to a computational procedure that converts text data, including a warning sentence or meeting information, into visual data suitable for presentation on a display apparatus of the terminal device.

The term “tracking information” refers to data generated by the information processing apparatus that associates action items with follow-up attributes such as deadlines, responsible entities, or status values, to manage execution of the action items.

The term “notification information” refers to data generated based on tracking information, which is transmitted to a terminal device and indicates reminders, updates, or alerts related to action items or follow-up events.

The term “overall meeting summary information” refers to information representing a summarized view of an entire meeting, generated by the generative artificial intelligence model based on aggregated character information and specific expressions for the meeting.

In one embodiment, the invention is implemented as a networked meeting support system including at least one server and a plurality of terminals interconnected via a communication network. Each terminal includes an input apparatus such as a microphone and a display and audio output apparatus such as a screen and a loudspeaker. The server includes at least one processor, a main memory, a non-transitory storage apparatus such as a database system, and a communication interface. The server executes a set of software modules including an audio reception module, a speech recognition client module, a natural language processing module, a prompt generation module for a generative AI model, a meeting record management module, a warning generation module, and a summary generation module.

The server uses general-purpose hardware, for example, a multi-core CPU and, optionally, a GPU for accelerating neural network inference. The server runs an operating system such as a server-class operating system and hosts application software implemented in a high-level language. The server communicates with external speech recognition services and text-to-speech services via standardized network protocols such as HTTPS. The server may interact with a cloud-based speech recognition API and a text-to-speech API, but these are treated functionally as speech recognition and speech synthesis engines, respectively, and can be implemented on-premises as alternative embodiments.

The terminal captures audio information through the microphone using an audio capture library or an operating system audio API. The terminal converts the analog audio signal into digital audio data, for example, 16-bit PCM at 16 kHz, and transmits the audio data to the server using either a streaming protocol such as WebSocket or chunked HTTP requests. The terminal attaches metadata to the audio data, such as a meeting identifier, a participant identifier, and timestamps, using a predefined message structure.

The server receives the digital audio data and temporarily stores it in a buffer in main memory. The server may store longer-term segments in a circular buffer data structure to maintain a limited time window of recent audio for processing. The server applies a speech recognition process by sending the audio data to a speech recognition engine. The server can use an external speech recognition API provided by a generic cloud service or, in another embodiment, an on-premises speech recognition engine based on an acoustic model and a language model implemented as a deep neural network, such as a recurrent neural network (RNN) or a transformer-based acoustic model.

The server obtains character information from the speech recognition process in the form of UTF-8 encoded text and, optionally, word-level timestamps and confidence scores. The server normalizes this character information by converting it to a uniform casing, removing extraneous pauses, and normalizing punctuation. The server then stores the normalized character information in a relational table or document structure in the storage apparatus, indexed by meeting identifier and time.

The server performs a natural language processing process on the character information. The server uses a natural language processing library configured to perform tokenization, lemmatization, part-of-speech tagging, and dependency parsing. The server represents each utterance as a structured data object containing a sequence of token structures. Each token structure includes attributes such as token string, lemma, part-of-speech tag, dependency relation, and a timestamp range mapped back to the original audio data.

The server detects specific expressions by applying a combination of rule-based pattern matching and machine-learned classifiers. The server uses pattern dictionaries for phrases indicating meeting topics, action-indicating phrases, and phrases indicative of deviation from a subject. For example, the server uses finite-state pattern matchers or regular expression automata over token sequences to detect expressions such as “next step,” “action item,” “we must,” “to be done,” or “by Friday,” as indicative of action items. The server also uses learned classifiers such as logistic regression models or small feed-forward neural networks that take as input token-level features, including n-gram embeddings, part-of-speech tag patterns, and dependency relations, and output probabilities for categories such as “topic-related,” “action-related,” or “off-topic.”

The server classifies specific expressions into categories of key points, action items, and off-topic expressions. The server uses rules such as “imperative mood verb +noun phrase” or “modal verb+base verb+time expression” as features for action item detection, and uses keywords from a stored agenda as features for topic-related expression detection. In one embodiment, the server maintains a meeting agenda vector representation generated from the textual agenda using a sentence embedding model. The server computes cosine similarity between the agenda vector and sentence embeddings of utterances to determine whether an utterance is on-topic or deviates from the subject.

The server constructs structured record data for each detected key point and action item. Each record includes fields such as item type, content text, meeting identifier, participant identifier, start and end time, and detection confidence. The server stores these records in a database table with indexed columns for meeting identifier and time, thereby enabling efficient retrieval and aggregation. By using a structured schema rather than unstructured text, the server improves data management and reduces overhead in subsequent queries and follow-up scheduling.

The server generates a prompt sentence for a generative AI model based on the character information and the detected specific expressions. The server constructs the prompt sentence by following a deterministic template that includes sections for context, extracted expressions, and explicit instructions. For example, the server can generate a prompt sentence of the following form:

“Here is a transcript of a meeting segment: [transcript text]. The following expressions were detected as key phrases: [list of specific expressions]. Please analyze the topic of the meeting segment and extract key points and action items in concise bullet points.”

In another concrete example, the server can generate a prompt sentence such as:

“Please analyze the following meeting dialogue: [recent utterances]. Detected expressions include potential action items and decisions. Output a list of key points and a list of action items, each with a short description and, if present, a due date described in the dialogue.”

The server sends this prompt sentence, together with a subset of the character information, to a generative AI model that is implemented as a neural network, such as a transformer-based sequence-to-sequence model. The generative AI model resides either on the same server or on an external inference server, and receives the prompt as tokenized text. The model uses learned parameters including word embeddings, attention matrices, and feed-forward layers. The model has been trained on text summarization and meeting-style dialogues, using a loss function such as cross-entropy between predicted tokens and ground-truth tokens, and weight parameters were updated using gradient-based optimization methods such as Adam.

The server receives summary information produced by the generative AI model, which may be output as structured text containing sections such as “Key Points:” and “Action Items:”. The server post-processes this summary information to align it with the existing structured record data. In one embodiment, the server re-parses the model output, identifies bullet points and date expressions, and merges them with previously detected structured record data, resolving conflicts and filling in missing fields. By providing the generative AI model with pre-filtered text and explicit specific expressions via the prompt sentence, the server reduces the input size, thereby reducing computation time and memory usage for inference and improving the stability and relevance of the model's output.

The server generates meeting information by combining the structured record data and the summary information. The meeting information includes a hierarchical data structure representing sections such as “Overview,” “Key Points,” and “Action Items,” with each section linked to original utterances via identifiers and timestamps. The server outputs the meeting information to terminals as formatted text or as a structured data payload, which the terminals then render on their displays. The terminals may present key points and action items in separate panes, with links allowing the user to play back corresponding audio segments. The terminal uses this link to request the associated audio data from the server or a media storage subsystem.

When the server detects expressions indicating deviation from a subject among the specific expressions, the server generates a warning message. The server selects a stored warning sentence from a warning message database, possibly using rotation or meeting context to avoid repetition. The server then calls a text-to-speech engine to synthesize audio data corresponding to the warning sentence. The synthesized audio process uses a parametric or neural vocoder model to convert phoneme sequences into waveform samples. The server then sends the audio data and the text of the warning message to the terminals. The terminals play the audio warning through their speakers and display the text warning on their screens. This real-time feedback loop relies on the server's detection of off-topic patterns using precomputed embeddings and rule-based thresholds, which reduces human moderator involvement and provides a consistent and faster reaction than manual control.

The server generates tracking information for action items. The tracking information associates each action item record with attributes such as deadline, responsible party, and status. The server parses date expressions and named entities from the character information and assigns default due dates if explicit dates are not present. The server stores tracking information in dedicated tables that support efficient querying by deadline and responsible party. The server then generates notification information, which contains reminders for upcoming or overdue action items. The server transmits this notification information to terminals via push notifications or email integration. By maintaining tracking information in a normalized schema, the server reduces redundancy and avoids repeated computation of derived attributes, thereby improving performance.

The server aggregates character information and specific expressions on a per-meeting basis. The server maintains a meeting-level context object representing the chronological sequence of utterances, detected expressions, and intermediate summaries. After the meeting ends, or at scheduled intervals, the server constructs an aggregated input for the generative AI model comprising selected key utterances and lists of specific expressions. The server then generates a prompt sentence such as:

“Please generate an overall summary of the following meeting. Here is a list of key utterances and detected key phrases. Provide a concise meeting summary, followed by a consolidated list of action items.”

The server sends this aggregated prompt to the generative AI model and receives overall meeting summary information. The server stores the overall meeting summary information in association with the structured record data, which allows rapid retrieval of both detailed and high-level views without reprocessing the entire raw transcript.

The server achieves technical improvements beyond mere automation of human note-taking. By separating speech recognition, natural language analysis, and generative summarization into distinct modules and by tightly integrating them through structured intermediate data (token sequences, specific expression lists, and structured record data), the server reduces redundant text parsing and re-tokenization that would otherwise occur when independent tools are used. The server also reduces network and computation load by providing the generative AI model with pre-filtered, context-rich prompt sentences instead of sending entire transcripts. This pipeline design results in lower latency during real-time meetings and reduces the number of tokens processed by the generative AI model, directly improving processing speed and lowering computational costs.

The server improves accuracy and stability because the specific expression detector acts as a pre-filter and guide for the generative AI model. The prompt sentence explicitly enumerates candidate key phrases and action phrases, which constrains the generative AI model's output and reduces hallucinations and omissions. The structured record data provides a secondary verification path, where mismatches between structured extraction and model-generated summaries can be detected and corrected. This dual-path design contributes to reduced error rates in key point and action item extraction compared to a system that relies solely on free-form summarization.

The server also imposes non-conventional rules and processing flows compared with typical human note-taking or simple transcription systems. For example, the server uses specialized agendas as vector representations and calculates similarity between these vectors and utterance vectors to decide topic relevance. This vector-based matching, together with temporal constraints and off-topic counters, leads to a rule set that a human moderator would not normally apply in real time. The server thus implements a novel control flow where topic deviation is detected and handled automatically according to numeric thresholds and embedding distances, causing technical changes in how often warnings are emitted and how meeting content is structured.

In another embodiment, the generative AI model is trained or fine-tuned specifically on meeting-style dialogues. The server or an associated training system constructs a training dataset comprising historical meeting transcripts, extracted specific expressions, and human-curated summaries. The generative AI model receives as input both raw transcript segments and lists of specific expressions. During training, the model parameters are updated to minimize a loss function that includes a term for summary token prediction and an auxiliary term for correct classification of action items. The training process uses mini-batch stochastic gradient descent with adaptive learning rates, and may employ data augmentation techniques such as synonym replacement or sentence shuffling. This training regimen enables the model to integrate specific expression cues into its attention mechanism, enhancing its ability to focus on relevant parts of the input.

In a further alternative embodiment, the server executes all components locally, including the speech recognition engine and the generative AI model, running on a dedicated hardware platform with specialized accelerators. The server uses fast in-memory data structures—such as shared memory queues and lock-free ring buffers—to pass data between modules. This hardware-software co-design reduces inter-process communication overhead, thereby further improving throughput and latency. In other embodiments, the system is deployed in a distributed manner across multiple servers, with specialized nodes handling audio ingestion, NLP analysis, and generative summarization. The server coordinates these nodes using message queues and distributed task schedulers.

The terminal may provide different user interfaces depending on device type. A desktop terminal may display a full meeting dashboard showing current transcript, detected key points, and newly generated action items. A mobile terminal may display only condensed key points and simplified warnings, while still receiving the same structured data. In all cases, the terminal serves mainly as an input-output device, while the core logic and data processing reside on the server, ensuring that improvements in processing speed, accuracy, and resource management accrue at the system level.

By designing the system around structured intermediate representations, explicit detection of specific expressions, guided prompt sentences for a generative AI model, and integrated storage and tracking, the server improves the functioning of the computer system as a whole. The server reduces the amount of data processed by high-cost components, minimizes repeated parsing operations, improves cache locality when accessing structured record data, and provides consistent real-time responses to off-topic content. These features collectively result in a technical effect of faster processing, reduced computational load, enhanced accuracy of meeting records, and improved usability of meeting information presented to users.

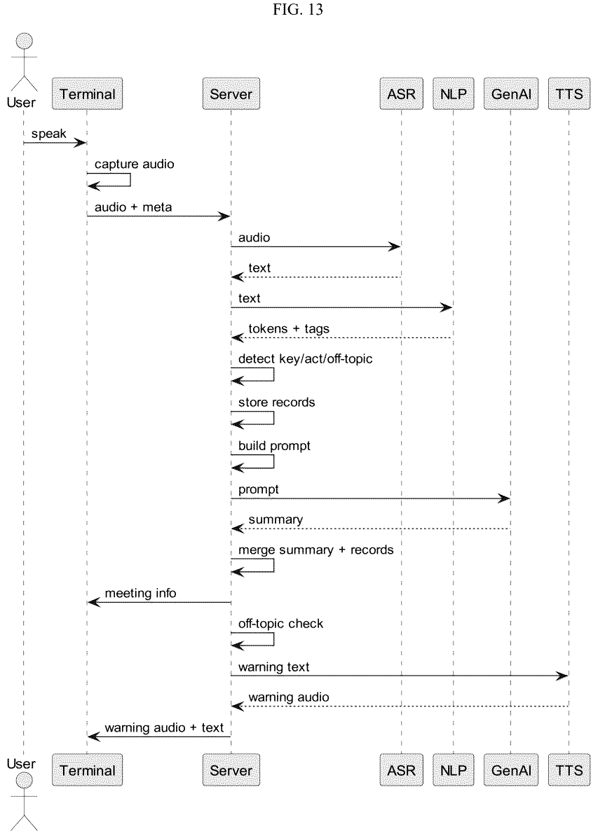

The following describes the processing flow using FIG. 13.

Step 1:
User speaks and terminal captures audio
The user speaks during a meeting about agenda items, decisions, or other topics.
The terminal uses a microphone and an operating system audio API to sample the user's speech as digital audio frames (for example, 16-bit PCM, mono, 16 kHz).
Input: Analog voice signal from the user.
Output: A sequence of digital audio frames buffered in the terminal's memory.
The terminal packages several consecutive frames into an audio chunk, attaches metadata such as meeting ID, user ID, and local timestamps, and stores this in a send buffer.

Step 2:
Terminal transmits audio to the server
The terminal opens or maintains a network connection, for example a WebSocket or HTTPS connection, to the server.
Input: Buffered audio chunk with associated metadata.
Output: A network message containing the audio chunk and metadata sent to the server.
The terminal serializes the metadata into a header (for example, JSON or another structured format) and appends the binary audio payload.
The terminal sends the message and waits for an acknowledgment or error code from the server.

Step 3:
Server receives and buffers audio
The server listens on a communication interface for incoming messages from terminals.
Input: Network message containing an audio chunk and metadata.
Output: An audio buffer object stored in server memory, indexed by meeting ID and user ID.
The server parses the message, validates the metadata, and checks format consistency (sample rate, bit depth).
The server writes the audio chunk into a per-meeting, per-user buffer (for example, a ring buffer) and records the receipt time in a log structure.

Step 4:
Server performs speech recognition
The server invokes a speech recognition engine to convert audio into text.
Input: Audio buffer object representing a contiguous interval of speech, plus metadata such as language code.
Output: Character information (recognized text) and auxiliary data such as word-level timestamps and confidence scores.
The server optionally resamples or re-encodes the audio into the format required by the speech recognition engine (for example, WAV or compressed format).
The server sends the audio data to the engine (locally or via an API call), receives a transcription result, and then decodes the result into a sequence of text segments aligned with the original timestamps.

Step 5:
Server normalizes and stores raw transcripts
The server preprocesses the recognized text to create a uniform representation.
Input: Raw recognized text with timestamps from the speech recognition engine.
Output: Normalized character information stored in a transcript data structure.
The server converts text to a unified casing as configured, removes or replaces non-linguistic tokens such as filler noises, and normalizes punctuation.
The server creates a transcript record containing meeting ID, user ID, start time, end time, and the normalized text, and writes this record into a transcript table or document store in the storage apparatus.

Step 6:
Server executes natural language processing
The server applies a natural language processing pipeline to the normalized text.
Input: Normalized character information and associated metadata (meeting ID, timestamps).
Output: A tokenized representation with linguistic annotations for each utterance.
The server passes the text to an NLP library that segments the text into tokens (words, punctuation), assigns part-of-speech tags, lemmas, and dependency relations.
The server groups tokens into sentence-level structures and creates a data object containing for each sentence the list of tokens and their attributes, linked back to the original transcript record through identifiers and timestamp offsets.

Step 7:
Server detects specific expressions
The server identifies expressions related to meeting topics, actions, and off-topic content.
Input: Linguistically annotated token sequences and a set of predefined patterns and classification models.
Output: A list of specific expressions, each labeled with a category such as “topic-related,” “action-related,” or “off-topic.”
The server runs rule-based matchers, for example phrase dictionaries and regular expression patterns, across the token sequences to find candidate phrases such as “next step,” “we need to,” or “weekend plans.”
The server also applies a classifier model to each sentence or phrase using features such as term embeddings, part-of-speech patterns, and dependency structures. The classifier outputs probabilities for each category, and the server selects the category with the highest probability above a predetermined threshold.
The server records each detected expression with its text span, category, confidence score, and time range.

Step 8:
Server extracts key points and action items
The server converts the detected expressions into structured meeting records.
Input: List of specific expressions with categories and timestamps.
Output: Structured record data representing key points and action items.
The server filters the specific expressions to those labeled as key points or action-related.
The server constructs records containing fields such as item type (key point or action item), textual content, associated speaker or user ID, related time interval, and detection confidence.
The server writes these records into a dedicated table or collection in the storage apparatus and updates in-memory indexes so that newly added items are immediately queryable.

Step 9:
Server detects topic deviation and updates off-topic state
The server determines whether the current conversation deviates from the meeting subject.
Input: Specific expressions labeled as off-topic, and agenda-related data or topic vectors.
Output: An updated off-topic state including a counter or flag indicating whether a warning should be issued.
The server compares the frequency and duration of off-topic expressions against configured thresholds.
The server may compute similarity scores between recent utterance embeddings and an agenda embedding; if similarity falls below a threshold while off-topic expressions are present, the server increments an off-topic counter.
The server updates an internal meeting context object to record the current deviation level and the most recent off-topic triggers.

Step 10:
Server generates a prompt sentence for the generative AI model
The server constructs a prompt sentence designed to guide the generative AI model.
Input: Recent character information, lists of specific expressions, and structured record data.
Output: A prompt sentence string (or strings) that describe context and request specific output from the generative AI model.
The server selects a time window of recent text (for example, the last few minutes of conversation) and retrieves related key points and action items from the structured record data.
The server fills a prompt template such as:
“Here is a transcript of a meeting segment: [transcript text]. Detected key phrases include: [list of specific expressions]. Please extract key points and action items from this segment.”
The server may compress or truncate the transcript text to stay within token limits, while keeping all detected specific expressions in the prompt.

Step 11:
Server calls the generative AI model and obtains summary information
The server submits the prompt sentence to the generative AI model and receives a structured summary.
Input: Prompt sentence, optionally accompanied by additional context text.
Output: Summary information that includes textual descriptions of key points and action items.
The server tokenizes the prompt sentence, sends the tokens to the generative AI model endpoint, and awaits the model's generated token sequence.
The server receives the generated sequence, decodes it into text, and parses the text into logical sections such as “Key Points:” and “Action Items:”, extracting each bullet or numbered item as a separate summary element.

Step 12:
Server reconciles model output with structured record data
The server aligns the model-generated summary with previously detected records.
Input: Summary information from the generative AI model and existing structured record data for the same time interval.
Output: Updated structured record data that incorporate refined or additional key points and action items.
The server compares each summarized key point or action item with existing records using string similarity metrics and time alignment.
The server merges duplicate items, updates content fields when the model provides clearer phrasing, and adds new items that were not detected earlier but match the meeting context.
The server stores the reconciled records back into the structured record storage and updates indexes to reflect any changes.

Step 13:
Server generates and outputs meeting information to terminals
The server composes human-readable meeting information that can be displayed on terminals.
Input: Reconciled structured record data and summary information.
Output: Meeting information objects containing sections for overview, key points, and action items, sent to terminals.

The server constructs a data structure that organizes key points and action items chronologically or by topic, including references to original timestamps.
The server serializes this structure into a format suitable for transmission (for example, JSON) and sends it to the terminals over the established connections.
The terminals receive this meeting information, parse it, and render it on display components such as lists, tables, or timeline views.

Step 14:
Server generates and sends warning messages when deviation is detected
The server issues warnings in response to persistent topic deviation.
Input: Off-topic state from Step 9 and stored warning sentences.
Output: Warning messages in audio and/or text form delivered to terminals.
The server checks whether the off-topic counter or deviation level exceeds a predefined threshold.

If a warning is needed, the server selects an appropriate warning sentence (for example, “Let's stay focused on the agenda.”).
The server calls a text-to-speech engine to synthesize audio data from the warning sentence and prepares a text payload for visual display.
The server sends both the audio and text components of the warning message to the terminals, which then play the audio and display the text notification to the users.

Step 15:
Server generates tracking information and notifications for action items
The server prepares follow-up information based on the action items.
Input: Structured record data for action items and any extracted due dates or responsible parties.
Output: Tracking information and notification messages scheduled or sent to terminals.
The server parses time expressions and named entities in the action item content to infer deadlines and assignees.
The server writes tracking records that link each action item to a deadline, a responsible user ID, and a status field.
The server generates notification messages such as reminder texts and schedules them for delivery via push channels or external communication services.
When the time condition is met, the server transmits the notification messages to terminals, prompting users to review or complete the associated action items.

Step 16:
Server aggregates meeting-level data and produces overall summaries
The server creates an overall summary for each meeting.
Input: All transcript segments, specific expressions, and structured record data associated with a meeting identifier.
Output: Overall meeting summary information associated with the meeting in the storage apparatus.
The server selects representative utterances and a consolidated list of key expressions for the entire meeting.
The server constructs a long-form prompt sentence such as:
“Please generate an overall summary of the following meeting. Use the listed key phrases and action items as guidance. Output a concise narrative summary and a consolidated action item list.”
The server sends this prompt to the generative AI model, receives an overall summary, and stores it with links to the structured record data.
This aggregated information allows subsequent retrieval of concise summaries without re-running heavy analysis on the full raw transcript.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog and meeting-support systems that use speech recognition and natural language processing suffer from several technical shortcomings at the level of computer processing itself. First, such systems typically perform speech-to-text conversion and simple keyword matching in a linear pipeline, without integrating the output of a generative AI model back into the low-level language processing components. As a result, recognition errors, ambiguous commands, and context-dependent expressions are propagated through the pipeline, which degrades the quality of structured data (for example, commands and parameters) stored in memory and used by downstream modules such as route planners or workflow engines.

Second, most existing systems invoke a generative AI model on raw or lightly processed text and treat the model's output as a separate summary or suggestion, without using it to correct or refine the structured information already extracted by deterministic language processing. This separation prevents the computing system from exploiting the model's global reasoning to improve the internal data representation (for example, command objects in memory), and causes inconsistencies between rule-based extraction results and AI-based interpretations. This leads to unstable behavior of navigation control or task management software that depends on those internal representations.

Third, known systems generally apply topic detection and notification logic based on simple thresholds or fixed rules, and they do not systematically control humorous warnings or other feedback signals as a function of the temporal pattern of conversation states. Because the processor does not dynamically adjust the frequency and content of warnings based on a history of topic status and responses, the system can overwhelm users with excessive prompts or fail to intervene when conversation drifts persist, thereby reducing the effectiveness and usability of the human-machine interface.

Fourth, in many architectures, extraction of action items or route instructions and distribution of such information to external terminals is performed as a disconnected post-processing step. The processor does not treat action-item identification, database registration, and distribution as an integrated part of the same control flow that uses the generative AI model, so the internal state of the system (for example, structured command data, conversation context, and feedback history) is fragmented across multiple modules. This fragmentation complicates implementation, increases latency, and makes it more difficult to optimize memory access patterns and network usage.

Accordingly, there is a need for a computer-implemented system and server architecture that: (i) acquires audio and converts it to character information; (ii) performs deterministic language processing to derive structured information; (iii) generates and applies prompt sentences to a generative AI model using conversation history; (iv) obtains from the generative AI model refined command content, attributes, topic status, and response messages; (v) uses this output both to correct or update the structured information and to control generation and timing of humorous warning messages; and (vi) consistently records and distributes action items. By tightly coupling deterministic language processing with generative AI feedback and by explicitly modeling conversation history and feedback history in the processor's control logic, the invention improves the functioning of the computer itself in terms of accuracy, consistency, and efficiency of internal data handling and user feedback generation.

The specific processing by the specific processing unit 290 of the data processing device 12 in Application Example 2 is realized by the following means.

The present invention provides a server comprising a processor configured to acquire audio information and convert the audio information into character information by using a speech recognition technique; perform language processing on the character information to extract structured information including command content and attribute information corresponding to the command content; update route information or work procedure information on the basis of the structured information and output an update result to an external apparatus; generate a prompt sentence for instructing a generative artificial intelligence model to perform processing including topic classification, extraction of key points, and determination of a topic status, on the basis of conversation history information including the character information and the structured information; input the prompt sentence and the conversation history information into the generative artificial intelligence model and obtain, from the generative artificial intelligence model, output information including the command content, the attribute information corresponding to the command content, the topic status, and a response message in accordance with the topic status; when the topic status included in the output information satisfies a predetermined condition, generate a humorous warning message as the response message and present the humorous warning message as audio or visual information to an output device; correct or update the structured information extracted by the language processing, on the basis of the command content and the attribute information corresponding to the command content obtained from the generative artificial intelligence model; specify an action item on the basis of the command content and the attribute information corresponding to the command content obtained from the generative artificial intelligence model, register the action item as record information in a storage device, distribute the record information to a user terminal via a communication unit; and control a frequency or an expression content of the humorous warning message, and output the humorous warning message in accordance with a user state, on the basis of the topic status of a plurality of utterances and an output history of the response message within a predetermined time period in the conversation history information. This enables the server to improve the internal consistency and accuracy of command and attribute data structures, to dynamically manage user feedback in real time based on conversation context and history, and to integrate action-item generation, storage, and distribution into a unified processing flow, thereby enhancing the technical performance of the computer system in processing audio-derived dialog information.

The term “audio information” refers to digital data representing sound, including, for example, speech captured via a microphone and converted into an electronic signal that can be processed by a computing device.

The term “character information” refers to text data obtained by converting audio information into sequences of characters, symbols, or code points that can be stored and processed by a computing device.

The term “speech recognition technique” refers to a computational method or algorithm that transforms audio information containing speech into corresponding character information, typically by analyzing acoustic features and mapping them to linguistic units.

The term “language processing” refers to a set of computational operations performed on character information, including at least one of tokenization, part-of-speech tagging, syntactic analysis, semantic analysis, or entity recognition, in order to derive structured information.

The term “structured information” refers to data represented in a predefined format, such as a record, object, or key-value pair, that includes at least command content and attribute information corresponding to the command content and is suitable for programmatic access and updating.

The term “command content” refers to information indicating an intention or instruction for a system to perform a specific operation, such as updating route information, executing a task, or changing a work procedure.

The term “attribute information corresponding to the command content” refers to parameter data associated with the command content, including, for example, a target, condition, time, location, or other contextual detail that specifies how the command content is to be executed.

The term “route information” refers to data indicating a path, itinerary, or sequence of positions or waypoints to be followed by an apparatus or process, and may include associated parameters such as timing, priority, or constraints.

The term “work procedure information” refers to data defining a sequence of operations, steps, or tasks to be performed in a process or workflow, together with associated conditions or resources.

The term “external apparatus” refers to any device or system that is separate from the server and is configured to receive update results, such as a vehicle controller, a robotic device, a terminal, or another computing system.

The term “conversation history information” refers to data representing a sequence of utterances or text segments previously processed by the system, including at least character information and structured information, and optionally timestamps, speaker identifiers, and topic status.

The term “topic classification” refers to a computational process that assigns one or more topic categories or labels to an utterance or a portion of the conversation history information, such as navigation-related, work-related, or off-topic.

The term “extraction of key points” refers to the identification, from character information or conversation history information, of important statements, decisions, instructions, or summaries that represent main ideas of the content.

The term “topic status” refers to information indicating a state or condition of a topic in an utterance or conversation segment, including, for example, whether the utterance is on-topic, of-topic, or partially related to a reference subject.

The term “prompt sentence” refers to a text input constructed to instruct a generative artificial intelligence model to perform a specified processing operation, the text input including at least instructions, context information, and optionally an output format specification.

The term “generative artificial intelligence model” refers to a trained computational model that receives a prompt sentence and related input data and produces text or structured output by generating new content based on learned patterns of natural language.

The term “output information” refers to data produced by the generative artificial intelligence model in response to a prompt sentence, and includes at least command content, attribute information corresponding to the command content, topic status, and a response message.

The term “response message” refers to text or content generated or selected by the system in accordance with the topic status, and is intended to be presented to a user as feedback, guidance, or notification.

The term “humorous warning message” refers to a response message that includes a warning or caution expressed with humorous or light-hearted wording, in order to draw user attention while reducing discomfort.

The term “output device” refers to a component or apparatus capable of presenting information to a user, including at least a display device for visual information or a speaker for audio information.

The term “correct or update” refers to modifying structured information by changing, supplementing, or replacing at least part of its contents based on additional information, such as results obtained from the generative artificial intelligence model.

The term “action item” refers to a discrete task or operation to be performed after the conversation, derived from command content and attribute information, and intended to be traceable and executable in a workflow.

The term “record information” refers to stored data representing at least one action item, including associated metadata such as origin, time of creation, and status, in a form suitable for retrieval and transmission.

The term “storage device” refers to a hardware component or subsystem capable of persistently storing data, such as a magnetic storage, solid-state storage, or any non-volatile memory.

The term “communication unit” refers to a functional element that enables the server to send and receive data over a communication network, using wired or wireless protocols.

The term “user terminal” refers to a device operated or observed by a user, such as a mobile terminal, a desktop device, a wearable device, or another computing terminal configured to receive and present record information.

The term “frequency of the humorous warning message” refers to a rate or number of times the humorous warning message is output within a given time period or a given number of utterances.

The term “expression content of the humorous warning message” refers to the wording, tone, length, or style of the humorous warning message as presented to the user.

The term “user state” refers to information indicating a condition related to a user, derived from conversation history information or other signals, such as a level of engagement, annoyance, confusion, or emotional state.

The term “output history of the response message” refers to data indicating when and how response messages, including humorous warning messages, have been output in the past within a specified period, and may include counts, timestamps, and types of responses.

The term “plurality of utterances” refers to two or more segments of speech or corresponding character information units that are processed as part of the conversation history information.

The term “predetermined time period” refers to a time interval defined in advance by configuration or program logic, during which topic status and response message outputs are evaluated.

In one embodiment, a server implements the claimed system by executing a program stored in a non-transitory computer-readable medium. The server includes at least one processor, a main memory, a non-volatile storage device, a network interface, and optionally a hardware accelerator such as a graphics processing unit. The server communicates with one or more terminals operated by users. Each terminal includes at least a microphone, a display device, a speaker, and a communication interface. The server is connected via a communication network to external services that provide speech recognition, text-to-speech, and generative AI capabilities.

The server acquires audio information from the terminal. The terminal captures the user's speech by using the microphone and converts the analog audio signal into digital samples, such as linear pulse-code modulated samples at a defined sampling rate and bit depth. The terminal transmits the audio data to the server over a secure transport protocol. The audio information includes, for example, utterances spoken during a meeting, during an operation in a workspace, or inside a vehicle.

The server converts the received audio information into character information by using a speech recognition technique. In one example, the server invokes a cloud-based speech recognition application programming interface, such as a generic cloud speech-to-text service, and passes the audio frames together with configuration parameters (language, sampling rate, model type). In another example, the server executes an on-premise speech recognizer including an acoustic model and a language model implemented by a recurrent neural network or a transformer network. In both cases, the server receives recognition results as text strings encoded in a character set, and stores the character information in a main-memory buffer and in a storage device.

The server performs language processing on the character information to extract structured information including command content and attribute information corresponding to the command content. The server uses a natural language processing library, such as a general-purpose library that performs tokenization, part-of-speech tagging, syntactic dependency parsing, and named-entity recognition. The server converts each utterance into a token sequence and a parse tree, and generates a data structure such as an object or record that stores, for each utterance, a list of tokens, their part-of-speech tags, dependency relations, and identified entities.

The server applies rule-based patterns to the parsed character information. For example, the server applies rules that recognize patterns of an imperative verb followed by a direct object or prepositional phrase, and classifies such patterns as command content. The server also applies rules that interpret temporal expressions, locations, and references to tasks as attribute information. The server stores the structured information in a normalized internal format, for example as key-value pairs such as “command_type: NAVIGATE”, “parameter: TURN_RIGHT”, “location: NEXT_INTERSECTION”, or “command_type: CREATE_ACTION_ITEM”, “parameter: SUBMIT_REPORT”, “deadline: NEXT_MONDAY”. By using explicit data structures for commands and attributes, the server can index, search, and update command information efficiently.

The server updates route information or work procedure information on the basis of the structured information and outputs an update result to an external apparatus. When the structured information indicates navigation-related command content, the server interacts with an external navigation or control module, such as a route-planning engine running on a vehicle control computer or a workflow engine controlling an industrial device. The server converts the abstract command content and attribute information into a specific change to a path representation or a workflow graph. For instance, the server identifies a node in a path graph representing a next intersection, inserts or modifies a direction attribute to cause a right turn, and transmits the updated graph to the external apparatus via a network interface.

When the structured information indicates a work-related procedure, the server modifies a workflow description stored in the storage device. The server may update a directed acyclic graph of tasks, assign attributes such as deadlines and assignees, and notify a separate task management component. By modifying internal route or procedure representations directly in memory according to structured command content, the server reduces the need for human operators to manually edit such data structures and thereby reduces latency and error.

The server generates a prompt sentence for instructing a generative AI model to perform processing including topic classification, extraction of key points, and determination of a topic status, on the basis of conversation history information including the character information and the structured information. The server maintains, in the storage device or main memory, conversation history information that includes, for each utterance, the corresponding character information, structured information, timestamps, and speaker identifiers. The server constructs a prompt sentence by concatenating: (i) system-level instructions to the generative AI model; (ii) a description of the desired output format; and (iii) part of the conversation history information.

The server, for example, constructs a prompt sentence such as:

“You are an assistant that analyzes spoken dialog converted to text.

From the following transcript, do the following tasks:
(1) Identify any command given by the user and extract the command and its parameters in a concise form.
(2) Determine whether the latest utterance is on-topic with respect to the main subject, or off-topic.
(3) If the latest utterance is off-topic, generate a short humorous warning that politely guides the user back to the main subject.

Output the following items in plain text:
‘Command: . . . ’ (or ‘Command: none’ if no command)
‘Parameters: . . . ’ (if any)
‘Topic status: on-topic’ or ‘Topic status: off-topic’
‘Humorous warning: . . . ’ (or ‘Humorous warning: none’ if on-topic)

Transcript:
[conversation text here]”

The server then appends the latest portion of the conversation history information after the “Transcript:” line.

The generative AI model is implemented, for example, as a transformer-based neural network. The generative AI model includes an encoder-decoder architecture with multiple attention heads, feed-forward layers, layer normalization, and learned positional encodings. The generative AI model is trained on large corpora of text sentences by using a sequence-to-sequence or next-token prediction objective. During training, the generative AI model minimizes a loss function, such as a cross-entropy loss, between predicted token distributions and ground-truth tokens. The generative AI model updates its internal weights by using a gradient-based optimization algorithm, such as stochastic gradient descent or a variant thereof with momentum and adaptive learning rates.

The server inputs the prompt sentence and the conversation history information into the generative AI model and obtains output information that includes the command content, the attribute information corresponding to the command content, the topic status, and a response message in accordance with the topic status. The server passes the prompt sentence as input tokens to the generative AI model via an application programming interface. The generative AI model processes the tokens through its attention layers and feed-forward layers, and outputs a sequence of tokens that is decoded by the server into text. The server parses the output text to locate lines such as “Command: . . . ”, “Parameters: . . . ”, “Topic status: . . . ”, and “Humorous warning: . . . ”, and constructs an internal representation of the output information.

The server uses explicit parsing rules for the generative AI output and does not rely on opaque model behavior. For example, the server splits lines by delimiters, normalizes labels to a canonical form, and validates possible values of topic status. If the generative AI output deviates from expectation, the server can fall back to default values or trigger a secondary prompt that corrects the format. This explicit parsing and validation step improves robustness and reduces error propagation in downstream modules.

When the topic status included in the output information satisfies a predetermined condition, the server generates a humorous warning message as the response message and presents the humorous warning message as audio or visual information to an output device. The server, for instance, considers the topic status to satisfy the condition when the status is “off-topic” and a minimum interval since a last warning has elapsed. The server extracts the humorous warning text and sends it to the terminal via a network interface.

The terminal receives the humorous warning text and presents it. The terminal may display the humorous warning on the display device as a text notification or convert the text into synthesized speech by invoking a text-to-speech engine. The text-to-speech engine can be implemented by a neural speech synthesizer that maps input text into spectrograms and then to waveform samples. The terminal plays the synthesized waveform through the speaker. By controlling not only the occurrence but also the style and timing of humorous messages according to conversation history, the server avoids overloading the user with repeated notifications.

The server corrects or updates the structured information extracted by the language processing on the basis of the command content and the attribute information corresponding to the command content obtained from the generative AI model. When the generative AI model identifies a refined command or parameter that differs from the original rule-based extraction, the server compares both representations and resolves conflicts by using consistency rules. For example, if the rule-based extraction has “Command: SET_MEETING” and the generative AI model has “Command: CREATE_ACTION_ITEM”, the server may adopt the latter if the conversation context suggests future tasks. The server then updates the structured information data structure in memory and in storage, so that downstream modules operate on a more accurate command representation.

The server specifies an action item on the basis of the command content and the attribute information corresponding to the command content obtained from the generative AI model, registers the action item as record information in a storage device, and distributes the record information to a user terminal via a communication unit. The server, for example, creates a record that includes fields for task description, responsible user, deadline, and originating conversation segment. The server stores the record in a database table indexed by meeting identifier and time, and sends a summary of the action item to each terminal participating in the session by using a push-notification protocol. This integration of generative AI output with a structured action-item store ensures that the internal representation of tasks is consistent, queryable, and linked to original dialog data.

The server controls a frequency or an expression content of the humorous warning message and outputs the humorous warning message in accordance with a user state, on the basis of the topic status of a plurality of utterances and an output history of the response message within a predetermined time period in the conversation history information. The server maintains counters of how many warnings have been emitted in the last time window, and maintains a history of topic status values. If the conversation remains frequently off-topic but warnings have been frequent, the server may reduce the intensity of subsequent warnings by selecting shorter or milder expressions. If the conversation has been mostly on-topic and then suddenly drifts, the server may choose a more elaborate humorous guidance. The server can store multiple templates for humorous responses and select them based on predicted user state, thereby adapting the human-computer interaction in a technically controlled manner.

The user interacts with the system in various use cases. In one example, the user participates in a meeting in a conference room. The terminal placed on a table captures the participants' speech and transmits audio to the server. The user may say, “The next action is to submit the report by next Monday.” The server converts this utterance to character information, extracts structured information indicating an action to “submit report” with a “next Monday” deadline, and constructs a prompt sentence including recent dialog. The generative AI model returns “Command: create action item” and “Parameters: submit report by next Monday.” The server corrects the internal structured information and registers an action item. After the meeting, the server distributes the record information, including the action item, to each user terminal.

In another example, the user rides in an autonomous vehicle and speaks instructions such as, “Please turn right at the next intersection, and by the way, yesterday's show was funny.” The terminal embedded in the vehicle sends audio to the server. The server extracts structured information indicating a navigation command to “turn right at next intersection,” and constructs a prompt sentence with the mixed navigation and casual content. The generative AI model returns a topic status of “off-topic” for the latter portion and provides a humorous warning such as “We are still driving; let us focus on the route.” The server updates the route information in the navigation module and instructs the terminal to present the humorous warning. As a result, the vehicle's control unit updates its path plan quickly and accurately, while the user receives context-aware feedback.

From a technical perspective, the server improves the functioning of the computer system itself. By first applying deterministic language processing to obtain structured information, and then using a generative AI model through carefully designed prompt sentences to refine and correct that structured information, the server creates a feedback loop that reduces recognition errors and inconsistencies in internal data structures. This results in more accurate route updates and action-item records stored in memory and databases. Because the server maintains structured command objects and conversation history with explicit data formats, it can perform indexing and retrieval operations more efficiently and can avoid repeated full-text scans.

The server reduces processing latency by limiting the input to the generative AI model to a bounded conversation history and by offloading rule-based extraction to efficient local language processing modules. The generative AI model is not invoked for every intermediate token, but only when sufficient context is accumulated. This architecture reduces communication overhead between the server and external AI services and improves overall throughput. Additionally, by adaptively controlling humorous warning output based on topic status history, the server avoids generating unnecessary messages, thereby reducing communication load to terminals and reducing text-to-speech computation.

The generative AI model operates according to a non-conventional pipeline that differs from manual processing by humans. The server constructs prompt sentences that include internal structured information and explicit output format instructions, which bias the generative AI model toward producing machine-parsable outputs rather than natural free-form prose. The server then uses deterministic parsing rules on the model's output to update internal data. The combination of rule-based extraction, structured prompt design, and structured output parsing forms a technical scheme that is tailored to computer implementation and not simply a replication of human summarization behavior.

In alternative embodiments, the server uses different hardware or software configurations while maintaining the core functional architecture. In one variant, the server incorporates a local generative AI model executed on a graphics processing unit or a tensor processing unit. In another variant, the server uses a recurrent neural network or a convolutional sequence model instead of a transformer network for the generative AI model. In a further variant, the server integrates the speech recognition component and the language processing component into a single end-to-end neural network that outputs both character information and preliminary structured information, which is then further refined by the generative AI model with similar prompt sentences.

In another embodiment, the terminal performs part of the language processing locally. The terminal tokenizes the character information and attaches metadata such as timestamps and speaker labels before sending it to the server. The server then performs the remaining extraction, prompt construction, and interaction with the generative AI model. This distributed architecture can reduce network usage and server load.

In yet another embodiment, the server uses different criteria for the predetermined condition that triggers humorous warnings. The server may compute a moving average of topic status scores, where intermediate levels reflect partially on-topic content, and convert the average into a discrete status. The server may also integrate a separate emotional-state estimator that analyzes prosodic features of the audio signal by using a neural classifier to estimate user frustration or boredom, and adjust warning frequency accordingly.

These embodiments share the common technical concept that the server uses a combination of deterministic language processing, structured data representations, and generative AI modeling with explicitly designed prompt sentences to improve internal data accuracy, control user feedback, and update external device states in real time. By designing the data flow, data structures, and processing sequence in this manner, the system provides concrete improvements in processing speed, accuracy, and resource utilization of the computer system that implements the invention.

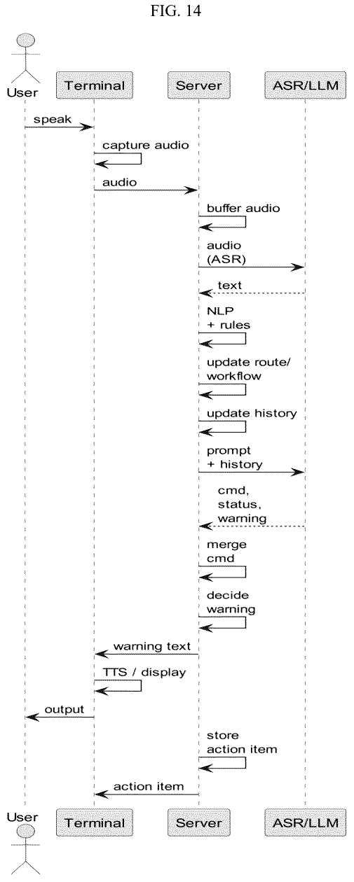

The following describes the processing flow using FIG. 14.

Step 1:
The user speaks utterances such as instructions, decisions, or casual remarks.
Input: No digital input; the user produces analog speech in the environment.
Output: Acoustic sound waves that represent the user's utterances and are capturable by the terminal's microphone.

Step 2:
The terminal captures the user's speech via a microphone and converts the analog acoustic signal into digital audio information.
Input: Acoustic sound waves from the user.
Processing: The terminal samples the analog signal at a predefined sampling rate (for example, 16 kHz) with a fixed bit depth (for example, 16 bits), performs analog-to-digital conversion, and segments the stream into frames of a fixed duration (for example, 10-30 ms).
Output: A stream of digitized audio frames (for example, PCM data) buffered in the terminal's memory.

Step 3:
The terminal transmits the digitized audio frames to the server over a communication network.
Input: The buffered audio frames stored in the terminal's memory.
Processing: The terminal packages audio frames into packets (for example, in an HTTP request body or a WebSocket message), adds session identifiers and timestamps, and sends them via a secure protocol over the network.
Output: Network packets containing audio information delivered to the server's network interface.

Step 4:
The server receives the audio packets and reconstructs a continuous audio stream for further processing.
Input: Network packets containing chunks of audio frames.
Processing: The server validates packet headers, reorders packets if needed, removes protocol headers, and concatenates the audio payloads into a continuous audio buffer in main memory, associated with a session identifier and timestamps.
Output: A continuous in-memory audio buffer representing the user's recent speech.

Step 5:
The server converts the audio buffer into character information by using a speech recognition technique.
Input: The audio buffer containing digitized speech.
Processing: The server sends the audio data with configuration parameters (language code, sampling rate, recognition mode) to a speech recognition engine, either a local engine or a remote API. The engine extracts acoustic features (for example, Mel-frequency cepstral coefficients), applies an acoustic model and a language model (for example, a neural-network-based recognizer), and decodes the most probable text sequence. The server receives recognition results in a machine-readable format and extracts the recognized text.
Output: Character information (text strings) representing the transcribed utterances, stored in the server's memory and optionally in a persistent log.

Step 6:
The server performs language processing on the character information to generate basic linguistic annotations.
Input: Character information for one or more utterances.
Processing: The server passes the text to a natural language processing library. The library tokenizes the text into tokens, assigns part-of-speech tags, and builds a dependency parse tree for each sentence. The server also runs named-entity recognition to identify entities such as times, locations, persons, and objects.
Output: Annotated text structures that include tokens, part-of-speech tags, dependency relations, and recognized entities for each utterance.

Step 7:
The server extracts structured information, including command content and attribute information corresponding to the command content, from the annotated text.
Input: Annotated text structures for each utterance.
Processing: The server applies rule-based patterns over the dependency trees and entity tags. The server matches patterns such as imperative verbs (“set,” “turn,” “submit,” “schedule”) followed by objects or prepositional phrases, and classifies them as command content. The server extracts attributes such as targets, deadlines, locations, or directions from entities and dependent phrases. The server constructs structured records or objects that store fields like “command_type,” “parameters,” and “context_utterance_id.”
Output: Structured information objects representing commands and their corresponding attributes for each detected command.

Step 8:
The server updates route information or work procedure information on the basis of the structured information and outputs an update result to an external apparatus.
Input: Structured information objects containing command content and attribute information.
Processing: When the command type relates to navigation, the server maps parameters (for example, “turn right at next intersection”) to nodes and edges in a route graph held in memory or storage. The server modifies the route graph to insert or update maneuvers and recalculates waypoints. When the command type relates to a work procedure, the server adds or changes nodes in a task graph or workflow description, assigning deadlines, priorities, or responsible entities. The server formats the updated route or workflow as a message and sends it via the network to a vehicle controller, a robotic controller, or another external apparatus.
Output: Updated route or work-procedure data transmitted to an external apparatus and stored as the current control state.

Step 9:
The server maintains conversation history information combining character information and structured information for later analysis.
Input: Newly processed utterances, including character information and structured information.
Processing: The server writes each utterance into a conversation history store with fields including the raw text, linguistic annotations, structured command objects (if any), timestamps, and speaker identifiers. The server keeps an in-memory sliding window of recent utterances, for example covering the last N utterances or the last T seconds.
Output: Conversation history information stored in the server's memory and/or database, indexed by session.

Step 10:
The server generates a prompt sentence for a generative AI model on the basis of the conversation history information.
Input: The recent window of conversation history information (including text and structured information).
Processing: The server assembles a prompt by concatenating predefined instructions, an output-format specification, and a textual representation of the recent utterances. The server may embed structured information, such as recognized commands or topics, in natural-language form to provide context. The server ensures that the prompt length stays within a target token budget by selecting only a bounded subset of history.
Output: A prompt sentence in text form that instructs the generative AI model to perform topic classification, extraction of key points, and topic-status determination.

Step 11:
The server provides the prompt sentence and the relevant conversation history text to the generative AI model and obtains output information.
Input: The constructed prompt sentence and the corresponding conversation history text.
Processing: The server sends the prompt text to the generative AI model via an API. The generative AI model, internally implemented as a multi-layer attention-based neural network, processes the tokenized prompt, computes attention scores across tokens, and generates an output sequence of tokens that encode its analysis (for example, command, parameters, topic status, humorous message). The server receives the generated text, decodes the tokens to characters, and parses the output by splitting into labeled sections such as “Command: . . . ,” “Parameters: . . . ,” “Topic status: . . . ,” and “Humorous warning: . . . .”
Output: Parsed output information including command content, attribute information, topic status, and a response message candidate.

Step 12:
The server corrects or updates the structured information obtained from language processing using the output information from the generative AI model.
Input: Original structured information from Step 7 and refined command content and attributes from Step 11.
Processing: The server compares the original command type and parameters with those provided by the generative AI model. The server applies resolution rules (for example, preferring the AI result when the AI output is consistent with context and more specific) and updates fields in the structured information objects. The server also updates indices or references in related route or workflow data structures so that the corrected commands are reflected in subsequent control actions.
Output: Updated structured information objects that combine deterministic extraction and generative AI refinement, stored in memory and optionally persisted.

Step 13:
The server determines whether the topic status satisfies a predetermined condition that triggers a humorous warning message.
Input: Topic status from the output information and a history of previous topic statuses and response outputs stored in conversation history.
Processing: The server evaluates logical conditions such as “topic_status=off-topic” and “time_since_last_warning>threshold.” The server may compute counts of recent off-topic utterances and maintain a moving window of topic states. Based on these metrics and configuration parameters, the server decides whether to generate and output a humorous warning.
Output: A decision flag indicating whether a humorous warning should be presented for the current utterance.

Step 14:
The server selects or generates the humorous warning message to be used as the response message and adapts its expression content based on past outputs.
Input: The candidate humorous warning text from the generative AI model, the decision flag from Step 13, and the output history of response messages.
Processing: If the decision flag is true, the server examines the length, tone, and recent usage of similar warnings. The server may directly use the AI-provided warning or map it to one of several pre-defined templates if needed for consistency. The server may shorten or soften the message if warnings have been frequent. The server records the selected message in the response history for future control of frequency and style.
Output: A finalized humorous warning message ready for delivery, or no message when the condition is not satisfied.

Step 15:
The server outputs the humorous warning message to the terminal for presentation to the user.
Input: The finalized humorous warning message from Step 14 and the identifier of the target terminal.
Processing: The server packages the warning text into a notification payload (for example, a JSON object or a simple text body in an HTTP response) and sends it through the communication unit to the terminal. The server logs the transmission time and associates the warning with the corresponding utterance in the conversation history.
Output: A network message containing the humorous warning message delivered to the terminal.

Step 16:
The terminal presents the humorous warning message to the user as audio and/or visual information.
Input: The notification payload containing the humorous warning text.
Processing: The terminal parses the payload, extracts the text, and, depending on configuration, either displays the text on the display device or synthesizes speech. For audio output, the terminal sends the text to a text-to-speech engine, which converts the text into a waveform. The terminal plays the waveform through the speaker. For visual output, the terminal renders the text in a notification area or overlay.
Output: Audible or visible feedback presented to the user, indicating that the topic is off-topic in a humorous manner.

Step 17:
The server specifies and records an action item based on the command content and attribute information refined by the generative AI model, and distributes the action item to user terminals.
Input: Updated structured information from Step 12 containing confirmed command content and related attributes.
Processing: The server determines whether the command corresponds to a follow-up task (for example, “submit report by next Monday”). If so, the server creates an action-item record with fields such as description, deadline, owner, and source utterance identifier. The server writes this record into a database table indexed by session and time. The server then formats a summary message and sends it via the communication unit to each relevant user terminal.
Output: Persisted action-item records in storage and notification messages containing action-item summaries delivered to user terminals.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

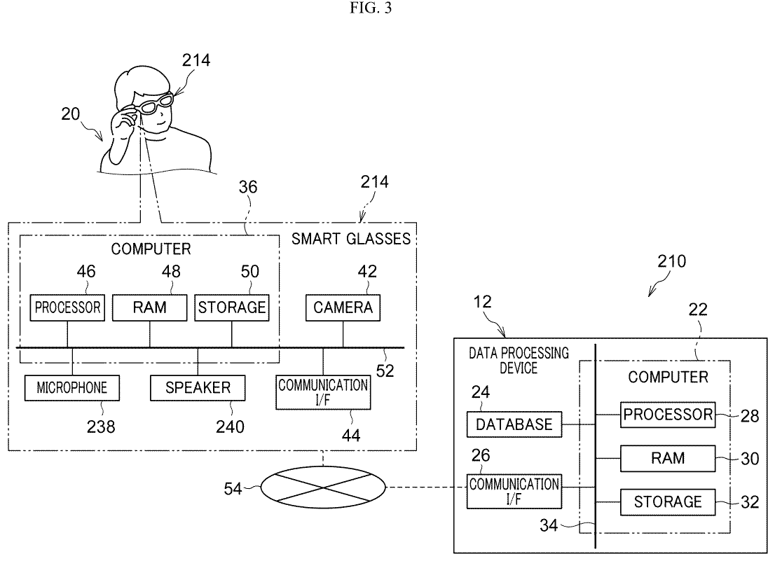

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

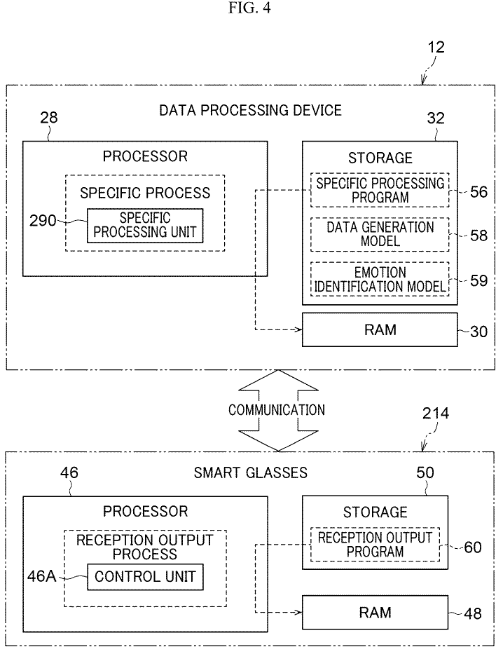

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

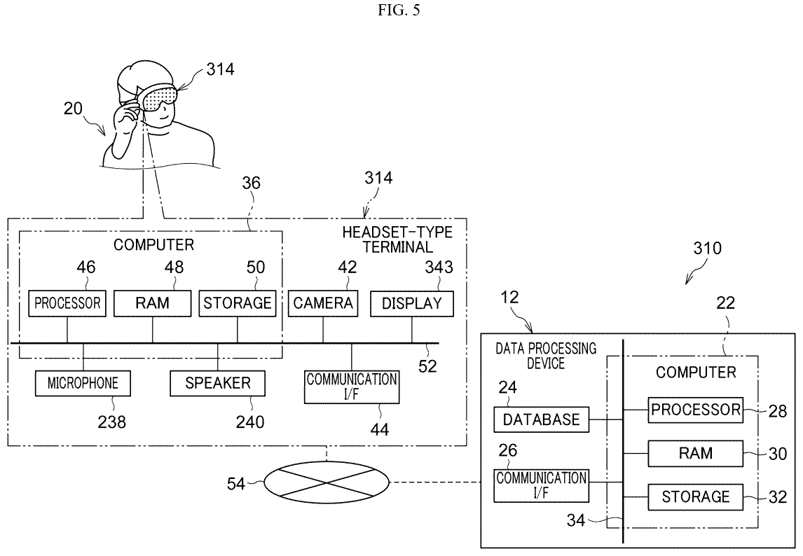

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

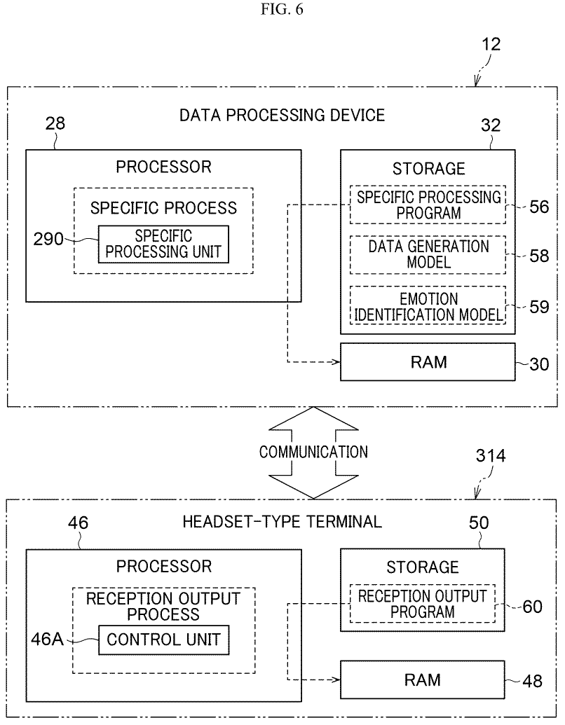

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

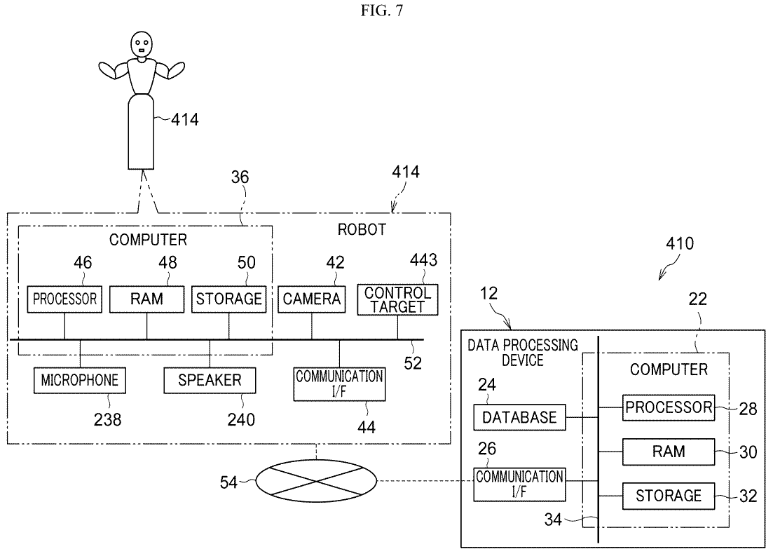

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

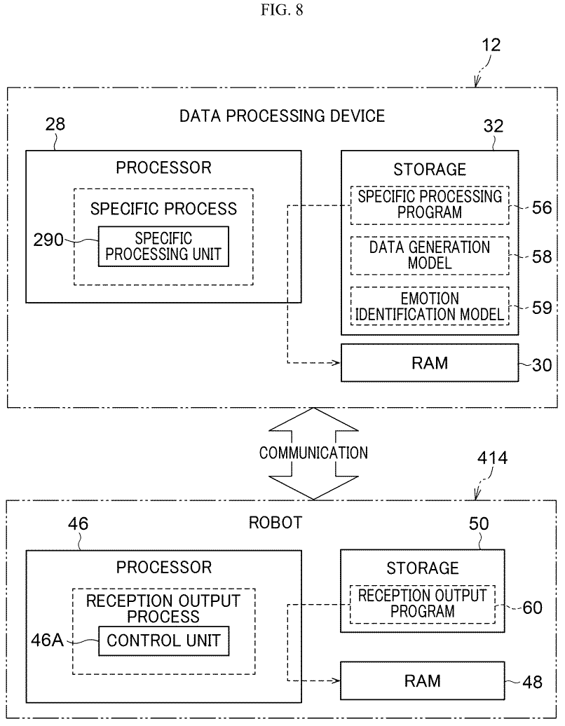

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

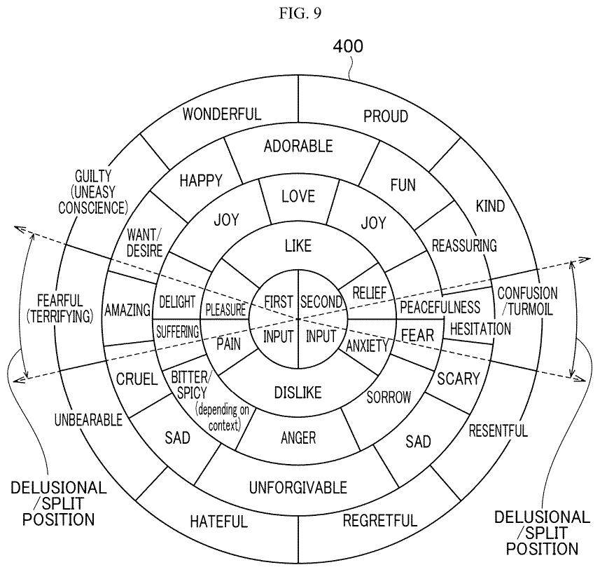

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

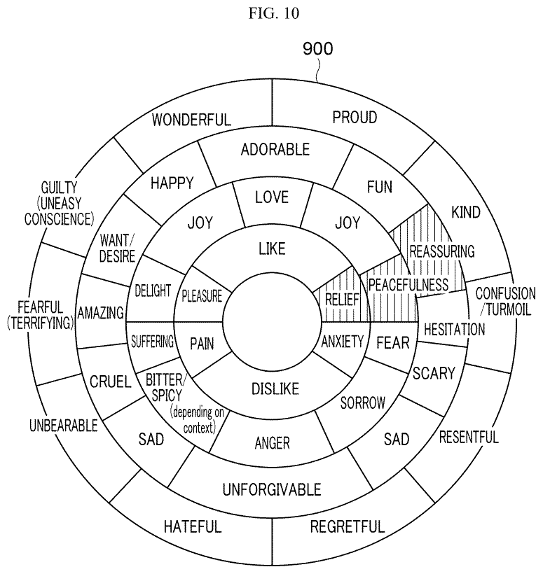

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire audio information and convert the audio information into character information by using a speech recognition technique,
aggregate the character information for each predetermined time range on the basis of time information, and generate a prompt sentence for inputting the aggregated character information as an analysis unit into a generative AI model,
input the prompt sentence and the aggregated character information into the generative AI model and analyze a topic and extract key points from the aggregated character information on the basis of natural language processing,
store the key points as structured data for each topic in a recording medium and sequentially update the structured data during progress of a conference,
determine, on the basis of an analysis result of the topic and agenda information of the conference, whether a conversation has deviated from a main subject,
output, to a terminal device of a participant, notification information including a humorous warning message when it is determined that the conversation has deviated from the main subject, on the basis of a determination result, and
generate, at an end of the conference, report information obtained by integrating the structured key points and information of action items based on the key points, and output and share the report information as an electronic document.

### (Supplementary 2)

The system according to supplementary 1,
wherein the processor is configured to
generate the prompt sentence input to the generative AI model including at least a first prompt sentence for causing the generative AI model to output the key points extracted from the character information as summary information, a second prompt sentence for causing the generative AI model to extract the action items from the key points, and a third prompt sentence for causing the generative AI model to determine whether the conversation has deviated from the main subject, and
obtain different types of analysis results from the generative AI model in correspondence with the respective prompt sentences.

### (Supplementary 3)

The system according to supplementary 1,
wherein the processor is configured to
generate, by using the generative AI model, a summary sentence including an outline of the entire conference, decided matters, and unresolved matters on the basis of the key points and the action items acquired from the generative AI model, and automatically generate an electronic document file including the summary sentence and the action items and distribute the electronic document file to the participants.

### Application Example 1

### (Supplementary 1)

A system comprising a processor,
wherein the processor is configured to
acquire audio information,
convert the audio information into character information by using a speech recognition technique,
store the character information and segment the character information into a plurality of utterance sections on the basis of time information,
analyze grammatical structure and semantic information of each utterance section by using a natural language processing technique, and extract meeting key points and action item candidates,
generate a prompt sentence for a generative artificial intelligence model on the basis of meeting objective information and the character information including the utterance sections, input the prompt sentence into the generative artificial intelligence model, and cause the generative artificial intelligence model to determine whether a topic of the utterance sections conforms to the meeting objective,
generate, when the topic is determined to deviate from the meeting objective, a prompt sentence for causing the generative artificial intelligence model to generate a humorous warning message according to content of the deviation and the meeting objective information, and acquire the humorous warning message from the generative artificial intelligence model,
record the extracted meeting key points and the action item candidates as structured information, and generate meeting summary information and action item information on the basis of the structured information and a response obtained from the generative artificial intelligence model, and
present the meeting summary information, the action item information, and the humorous warning message to meeting participants via an information terminal device.

### (Supplementary 2)

The system according to supplementary 1,
wherein the processor is configured to convert the meeting summary information and the action item information into task information compatible with a work management service provided by an external information processing device, register the task information in the work management service via a communication network, and notify the information terminal device of a registration result.

### (Supplementary 3)

The system according to supplementary 1,
wherein the processor is configured to cause, as the prompt sentence input to the generative artificial intelligence model, a control sentence to include the meeting objective information, character information of a recent utterance section, and instruction information relating to topic conformity determination and generation of the humorous warning message, and to cause the generative artificial intelligence model to perform at least one of the topic conformity determination and the generation of the humorous warning message in response to the control sentence.

### Example 2

### (Supplementary 1)

A system comprising a processor,
wherein the processor is configured to
acquire audio information representing speech of a meeting participant from an input apparatus of a terminal device and transmit the audio information to an information processing apparatus via a communication protocol,
convert the audio information into character information by executing a speech recognition process in the information processing apparatus,
analyze the character information by executing a natural language processing process in the information processing apparatus to detect specific expressions including expressions related to a meeting topic, expressions indicating an action, and expressions indicating deviation from a subject, extract, from the specific expressions, expressions indicating key points of the meeting and expressions indicating action items, and store the extracted expressions as structured record data in a storage apparatus of the information processing apparatus,
generate, in the information processing apparatus, a prompt sentence based on the character information and the specific expressions, the prompt sentence being configured to instruct a generative artificial intelligence model to analyze a topic and to extract key points, input the prompt sentence to the generative artificial intelligence model, and obtain summary information from the generative artificial intelligence model,
generate, in the information processing apparatus, meeting information including the key points and the action items based on the summary information and the structured record data, and output the meeting information to an output apparatus of the terminal device, and
generate, in the information processing apparatus, a warning message based on a stored warning sentence when the expressions indicating the deviation from the subject are detected among the specific expressions, and output the warning message from the information processing apparatus to the terminal device by a synthesized audio process or a visual display process.

### (Supplementary 2)

The system according to supplementary 1,
wherein the processor is configured to
generate tracking information corresponding to the action items included in the structured record data, create notification information based on the tracking information, and transmit the notification information to the terminal device via the communication protocol to support follow-up after the meeting.

### (Supplementary 3)

The system according to supplementary 1,
wherein the processor is configured to
aggregate the character information and the specific expressions on a per-meeting basis in the information processing apparatus, input an aggregation result and the prompt sentence to the generative artificial intelligence model to cause the generative artificial intelligence model to generate overall meeting summary information, and store the overall meeting summary information in association with the structured record data in the storage apparatus.

### Application Example 2

### (Supplementary 1)

A system comprising a processor,
wherein the processor is configured to
acquire audio information and convert the audio information into character information by using a speech recognition technique,
perform language processing on the character information to extract structured information including command content and attribute information corresponding to the command content,
update route information or work procedure information on the basis of the structured information and output an update result to an external apparatus,
generate a prompt sentence for instructing a generative artificial intelligence model to perform processing including topic classification, extraction of key points, and determination of a topic status, on the basis of conversation history information including the character information and the structured information,
input the prompt sentence and the conversation history information into the generative artificial intelligence model and obtain, from the generative artificial intelligence model, output information including the command content, the attribute information corresponding to the command content, the topic status, and a response message in accordance with the topic status,
when the topic status included in the output information satisfies a predetermined condition, generate a humorous warning message as the response message and present the humorous warning message as audio or visual information to an output device, and
correct or update the structured information extracted by the language processing, on the basis of the command content and the attribute information corresponding to the command content obtained from the generative artificial intelligence model.

### (Supplementary 2)

The system according to supplementary 1,
wherein the processor is configured to
specify an action item on the basis of the command content and the attribute information corresponding to the command content obtained from the generative artificial intelligence model, register the action item as record information in a storage device, and distribute the record information to a user terminal via a communication unit.

### (Supplementary 3)

The system according to supplementary 1,
wherein the processor is configured to
control a frequency or an expression content of the humorous warning message, and output the humorous warning message in accordance with a user state, on the basis of the topic status of a plurality of utterances and an output history of the response message within a predetermined time period in the conversation history information.

What is claimed is:

1. A system comprising:
circuitry configured to:
receive, via a communication interface coupled to a packet-switched network, audio data streams from a plurality of terminal devices, and convert the audio data streams into character string data by executing speech recognition processing using an acoustic model comprising a deep neural network and a language model to generate token sequences;
segment the character string data into utterance sections based on temporal boundary information derived from silence detection in the audio data streams, and analyze grammatical structure and semantic information of each utterance section by executing natural language processing including tokenization, dependency parsing, and semantic embedding to extract topic classification vectors, salient content segment data, and task indicator data;
generate an instruction sequence based on the character string data and the extracted topic classification vectors, input the instruction sequence into a generative neural network model comprising a transformer-based architecture with multi-layer self-attention sublayers and feed-forward sublayers to cause the generative neural network model to generate summary segment data and structured record data derived from the salient content segment data;
store the structured record data in a storage device;
compute a deviation score by calculating a cosine similarity between a vector representation of a current utterance section and a vector representation of reference topic data stored in the storage device, and generate, when the deviation score exceeds a threshold value, alert notification data including a redirection message, and transmit the alert notification data to at least one terminal device of the plurality of terminal devices via the communication interface; and
aggregate the salient content segment data and the structured record data to generate output data including a summary section and a record section, and transmit the output data to the plurality of terminal devices via the communication interface.

2. The system according to claim 1, wherein the circuitry is further configured to:
execute the speech recognition processing by computing acoustic feature vectors including Mel-frequency cepstral coefficients from the audio data streams, inputting the acoustic feature vectors to the acoustic model implemented as a deep neural network, and decoding a most probable token sequence using a beam search algorithm.

3. The system according to claim 2, wherein the circuitry is further configured to:
segment the character string data by detecting silence intervals exceeding a predetermined duration in the audio data streams, and assign speaker identification labels to each utterance section using a speaker diarization algorithm applied to the acoustic feature vectors.

4. The system according to claim 3, wherein the circuitry is further configured to:
aggregate the character string data for each predetermined time range on the basis of the temporal boundary information, and generate the instruction sequence using the aggregated character string data as an analysis unit input for the generative neural network model.

5. The system according to claim 4, wherein the circuitry is further configured to:
generate the instruction sequence including at least a first instruction portion for causing the generative neural network model to output the salient content segment data as summary information, a second instruction portion for causing the generative neural network model to extract the structured record data from the salient content segment data, and a third instruction portion for causing the generative neural network model to determine whether a current topic has deviated from the reference topic data.

6. The system according to claim 1, wherein:
the generative neural network model comprises a multi-layer self-attention architecture with multi-head attention sublayers, feed-forward sublayers, and layer normalization components, and the circuitry is configured to control decoding of the generative neural network model using inference parameters including a maximum output length, a sampling temperature, and a decoding strategy parameter.

7. The system according to claim 6, wherein the circuitry is further configured to:
parse an output token sequence of the generative neural network model by detecting structured delimiter markers, and extract from the output token sequence at least a topic label, a summary text segment, a task description, and assignee and deadline metadata.

8. The system according to claim 7, wherein the circuitry is further configured to:
sequentially update the salient content segment data stored in the storage device as new utterance sections are processed, maintaining a running structured data representation that evolves during progress of a collaborative session.

9. The system according to claim 1, wherein the circuitry is further configured to:
compare the topic classification vectors against the reference topic data by computing a semantic similarity score between a vector representation of a current utterance section and a vector representation of the reference topic data, and determine that the deviation score exceeds the threshold value when the semantic similarity score falls below a predetermined similarity threshold.

10. The system according to claim 9, wherein the circuitry is further configured to:
generate the alert notification data by generating a further instruction sequence for the generative neural network model that includes a description of the deviation and the reference topic data, inputting the further instruction sequence into the generative neural network model, and acquiring from the generative neural network model the redirection message formatted as a context-aware notification.

11. The system according to claim 10, wherein the circuitry is further configured to:
control a frequency or an expression style of the alert notification data based on an output history of previous alert notifications within a predetermined time period and a topic status of a plurality of utterance sections, and suppress generation of the alert notification data when a rate of previous alert notifications exceeds a rate threshold.

12. The system according to claim 1, wherein the circuitry is further configured to:
generate the output data by using the generative neural network model to produce a summary sentence including an outline of an entire collaborative session, decided matters, and unresolved matters on the basis of the salient content segment data and the structured record data, and automatically generate an electronic document file including the summary sentence and the structured record data.

13. The system according to claim 12, wherein the circuitry is further configured to:
convert the structured record data into task information compatible with an external work management service, transmit the task information to the external work management service via the communication interface, and transmit a registration result notification to the plurality of terminal devices.

14. The system according to claim 1, wherein the circuitry is further configured to:
perform language processing on the character string data to extract structured command data including command content and attribute information corresponding to the command content, and update route information or work procedure information stored in the storage device on the basis of the structured command data.

15. The system according to claim 14, wherein the circuitry is further configured to:
correct or update the structured command data extracted by the language processing on the basis of command content and attribute information obtained from the generative neural network model, and reconcile differences between the language-processing-extracted structured command data and the generative-neural-network-model-derived command content.

16. The system according to claim 1, wherein the circuitry is further configured to:
generate tracking information corresponding to the structured record data, create follow-up notification data based on the tracking information including reminder messages at predetermined intervals relative to temporal deadline data associated with the structured record data, and transmit the follow-up notification data to the plurality of terminal devices via the communication interface.

17. The system according to claim 16, wherein:
the audio data streams represent speech of meeting participants in a conference, the reference topic data comprises agenda information of the conference, the alert notification data includes a humorous warning message encouraging the meeting participants to return to the agenda, the output data comprises a meeting minutes document, and the structured record data comprises action items assigned to individual meeting participants with due dates.

18. A system comprising:
circuitry configured to:
receive, via a communication interface coupled to a packet-switched network, audio data from an input apparatus of a terminal device, and convert the audio data into character string data by executing speech recognition processing;
analyze the character string data by executing natural language processing to detect specific expression patterns including topic-related expressions, action-indicating expressions, and deviation-indicating expressions;
extract, from the specific expression patterns, salient content segment data and task indicator data, and store the salient content segment data and the task indicator data as structured record data in a storage device;
generate an instruction sequence based on the character string data and the specific expression patterns, the instruction sequence being configured to instruct a generative neural network model comprising a transformer-based architecture to analyze a topic and to extract salient content segments, and input the instruction sequence to the generative neural network model to obtain summary information;
generate, based on the summary information and the structured record data, output information including the salient content segment data and the task indicator data, and transmit the output information to the terminal device via the communication interface; and
generate, when the deviation-indicating expressions are detected among the specific expression patterns, a notification message based on stored notification templates, and transmit the notification message to the terminal device via the communication interface as synthesized audio data or visual display data.

19. The system according to claim 18, wherein the circuitry is further configured to:
aggregate the character string data and the specific expression patterns on a per-session basis, input an aggregation result and a further instruction sequence to the generative neural network model to cause the generative neural network model to generate overall session summary information, and store the overall session summary information in association with the structured record data in the storage device.

20. A method performed by circuitry of a system, the method comprising:
receiving, via a communication interface coupled to a packet-switched network, audio data streams from a plurality of terminal devices, and converting the audio data streams into character string data by executing speech recognition processing using an acoustic model comprising a deep neural network and a language model to generate token sequences;
segmenting the character string data into utterance sections based on temporal boundary information derived from silence detection in the audio data streams, and analyzing grammatical structure and semantic information of each utterance section by executing natural language processing including tokenization, dependency parsing, and semantic embedding to extract topic classification vectors, salient content segment data, and task indicator data;
generating an instruction sequence based on the character string data and the extracted topic classification vectors, inputting the instruction sequence into a generative neural network model comprising a transformer-based architecture with multi-layer self-attention sublayers and feed-forward sublayers to cause the generative neural network model to generate summary segment data and structured record data derived from the salient content segment data;
storing the structured record data in a storage device;
computing a deviation score by calculating a cosine similarity between a vector representation of a current utterance section and a vector representation of reference topic data stored in the storage device, and generating, when the deviation score exceeds a threshold value, alert notification data including a redirection message, and transmitting the alert notification data to at least one terminal device of the plurality of terminal devices via the communication interface; and
aggregating the salient content segment data and the structured record data to generate output data including a summary section and a record section, and transmitting the output data to the plurality of terminal devices via the communication interface.
